(19) United States
(12) Patent Application Publication
(10) Pub. No.: US 2011/0282551 A1
(43) Pub. Date: Nov. 17, 2011

(54) POWER STEERING APPARATUS

(75) Inventors: Mitsuo SASAKI, Hadano-shi (JP); Tsukasa Miyajima, Atsugi-shi (JP); Kazuya Yamano, Atsugi-shi (JP)

(73) Assignee: HITACHI AUTOMOTIVE SYSTEMS, LTD.

(21) Appl. No.: 13/048,269

(22) Filed: Mar. 15, 2011

(30) Foreign Application Priority Data
May 11, 2010 (JP) 2010-108917

(51) Int. Cl. B62D 6/00

(52) U.S. Cl. 701/42

(57) ABSTRACT

A power steering apparatus includes a power cylinder configured to assist a steering force of a steering mechanism; a bidirectional pump; a flow speed detecting section configured to detect or estimate a flow speed of working fluid flowing in a hydraulic circuit constituted by the power cylinder, the bidirectional pump and the like; a fluid temperature detecting section configured to detect or estimate a temperature of working fluid; a torque sensor configured to detect a steering torque which is applied to the steering mechanism; an electric motor configured to drive the bidirectional pump; and a motor control circuit configured to control the electric motor. The motor control circuit includes a base-current command value calculating circuit configured to calculate a current command value on the basis of the steering torque, a corrected-current command-value calculating circuit configured to calculate a corrected-current command value from the current command value to cause the corrected-current command value to become larger as the flow speed is higher and as the working-fluid temperature is lower, and a motor drive circuit configured to drive the electric motor on the basis of the corrected-current command value.

### BACKGROUND OF THE INVENTION

The present invention relates to a power steering apparatus configured to assist a driver in steering force by using hydraulic pressure.

U.S. Patent Application Publication No. 2006/0108172 (corresponding to Japanese Patent Application Publication No. 2006-143026) discloses a previously-proposed power steering apparatus. In this technique, hydraulic pressure is supplied/discharged to/from right and left pressure chambers of a power cylinder by driving a rotation of bidirectional pump by an electric motor, and thereby, a steering force is assisted by the right and left pressure chambers of the power cylinder. By driving the electric motor on the basis of an oil temperature estimated from the number of revolutions per unit time of the electric motor, a variation of steering assist force (directly) based on an oil-temperature variation (viscosity variation) is suppressed in order to improve a steering feeling of driver.

### SUMMARY OF THE INVENTION

However, in the above power steering apparatus, a pressure loss which is caused in the pump and pipe passages and the like due to the viscosity variation of working oil is not considered. Hence, there is a problem that a variation of steering assist force based on such a pressure loss cannot be sufficiently suppressed.

It is therefore an object of the present invention to provide a power steering apparatus devised to sufficiently suppress the variation of steering assist force based on the pressure loss which is caused in the pipe passages and the like due to the viscosity variation of working fluid.

According to one aspect of the present invention, there is provided a power steering apparatus comprising: a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle; a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation; a first oil passage connecting the first pressure chamber with the first discharge port; a second oil passage connecting the second pressure chamber with the second discharge port; a flow speed detecting section configured to detect or estimate a flow speed of working fluid flowing in a hydraulic circuit constituted by the power cylinder, the bidirectional pump and the first and second oil passages; a fluid temperature detecting section configured to detect or estimate a temperature of the working fluid; a torque sensor configured to detect a steering torque which is applied to the steering mechanism; an electric motor configured to drive the bidirectional rotation of the bidirectional pump; and a motor control circuit configured to control the electric motor, the motor control circuit including a base-current command value calculating circuit configured to calculate a current command value for controlling the electric motor on the basis of the steering torque, a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as the flow speed is higher and as the working-fluid temperature is lower, and a motor drive circuit configured to drive the electric motor on the basis of the corrected-current command value.

According to another aspect of the present invention, there is provided a power steering apparatus comprising: a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle; a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation; a first oil passage connecting the first pressure chamber with the first discharge port; a second oil passage connecting the second pressure chamber with the second discharge port; a reservoir tank retaining working fluid to adjust an amount of working fluid flowing in a hydraulic circuit constituted by the power cylinder, the bidirectional pump and the first and second oil passages; a flow speed detecting section configured to detect or estimate a flow speed of working fluid flowing in the hydraulic circuit; a torque sensor configured to detect a steering torque which is applied to the steering mechanism; a motor drive device including an electric motor and a motor control circuit, wherein the electric motor is provided to the bidirectional pump and configured to drive the bidirectional rotation of the bidirectional pump, wherein the motor control circuit is configured to control the electric motor; a control circuit housing receiving the motor control circuit; and a temperature sensor provided in the reservoir tank or the control circuit housing and configured to sense a working-fluid temperature or an ambient temperature inside the control circuit housing which serves as a correction-purpose temperature, wherein the motor control circuit includes a base-current command value calculating circuit configured to calculate a current command value for controlling the electric motor on the basis of the steering torque, a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as a steering angular speed is higher and as the correction-purpose temperature is lower, and a motor drive circuit configured to drive the electric motor on the basis of the corrected-current command value.

According to still another aspect of the present invention, there is provided a power steering apparatus comprising: a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle; a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation; a first oil passage connecting the first pressure chamber with the first discharge port; a second oil passage connecting the second pressure chamber with the second discharge port; a steering speed detecting section configured to detect or estimate a steering speed of a steering wheel linked with the steering mechanism; a fluid temperature detecting section configured to detect or estimate a temperature of working fluid; a torque sensor configured to detect a steering torque which is applied to the steering mechanism; an electric motor configured to drive the bidirectional rotation of the bidirectional pump; and a motor control circuit configured to control the electric motor, the motor control circuit including a base-current command value calculating circuit configured to calculate a current command value for controlling the electric motor on the basis of the steering torque, a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as the steering speed is higher and as the working-fluid temperature is lower, and a motor drive circuit configured to drive the electric motor on the basis of the corrected-current command value.

The other objects and features of this invention will become understood from the following description with reference to the accompanying drawings.

### BRIEF DESCRIPTION OF THE DRAWINGS

FIG. 1 is a schematic system configuration view of a power steering apparatus in an embodiment according to the present invention.

FIG. 2 is a longitudinal cross-sectional view showing a structure of hydraulic-pressure supply means shown in FIG. 1.

FIG. 3 is a control block diagram of a control unit shown in FIG. 2.

FIG. 4 is a control block diagram of a correction control-current calculating section shown in FIG. 3.

FIG. 5 is a map that is used for calculating a correction control current shown in FIG. 4.

FIG. 6 is a map that is used for a limit processing in a limit processing section shown in FIG. 4.

FIG. 7 is a flowchart showing control contents in a correction control-current calculating section shown in FIG. 3.

FIG. 8 is a control block diagram in a tank oil-temperature calculating section shown in FIG. 3.

FIG. 9 is a flowchart showing control contents of the tank oil-temperature calculating section shown in FIG. 8.

FIG. 10 is a table showing respective transitions of a tank oil-temperature estimate value, a FET estimate temperature and a tank oil-temperature actually-measured value after an ignition switch is turned off.

FIG. 11 is a flowchart showing control contents in a self-maintaining-function control section shown in FIG. 3.

FIG. 12 is a flowchart according to a basic control in the self-maintaining-function control section shown in FIG. 3.

FIG. 13 is a table showing a variation of steering force with a variation of oil temperature in a power steering apparatus of comparative technique.

FIG. 14 is a table showing a variation of steering force with a variation of oil temperature in the power steering apparatus according to the embodiment of the present invention.

### DETAILED DESCRIPTION OF THE INVENTION

Hereinafter, embodiments of power steering apparatus according to the present invention will be explained in detail referring to the drawings. In the following embodiments, the power steering apparatus according to the present invention is applied as a hydraulic power steering apparatus for a vehicle (automobile).

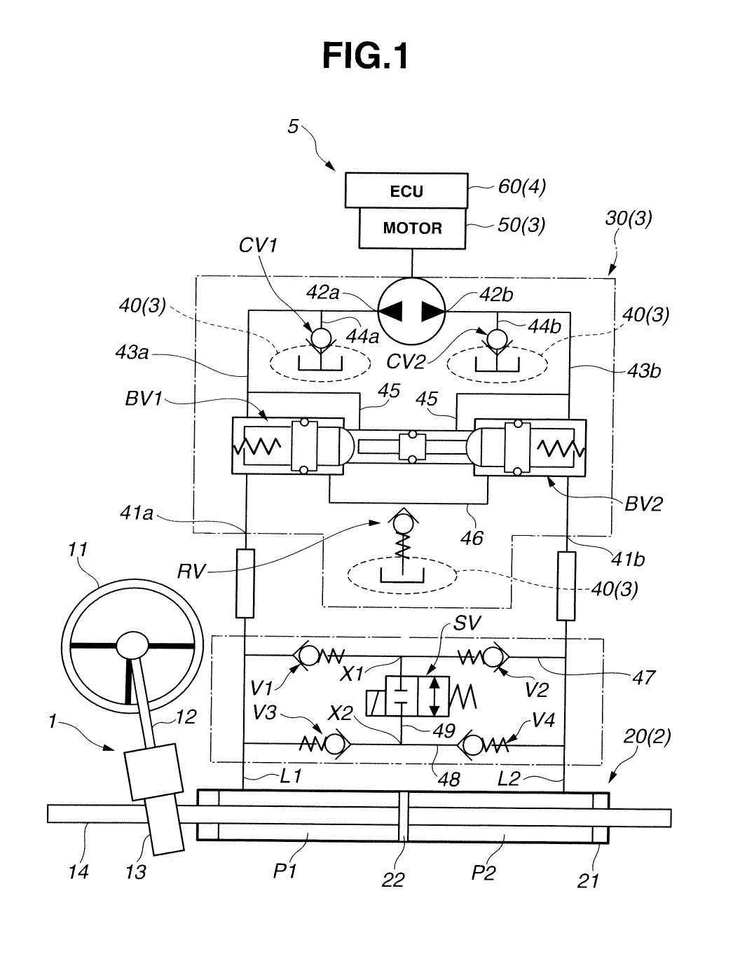

FIG. 1 is a schematic view showing a power steering apparatus in an embodiment according to the present invention.

The power steering apparatus shown in FIG. 1 includes a steering-force transmitting section (or steering-force transmitting means) 1, a steering-force assisting section (or steering-force assisting means) 2, a hydraulic-pressure supplying section (or hydraulic-pressure supplying means) 3, and a control section (or control means) 4. The steering-force transmitting section 1 functions to transmit a steering force (steering torque) of a driver to steerable road wheels (not shown). The steering-force assisting section 2 functions to produce a steering assist force (steering assist torque) by hydraulic pressure (oil pressure), on the basis of the steering torque inputted to the steering-force transmitting section 1. The hydraulic-pressure supplying section 3 functions to supply a hydraulic pressure for generating the steering assist torque to the steering-force assisting section 2. The control section 4 functions to drive and control the hydraulic-pressure supplying section 3. The hydraulic-pressure supplying section 3 and the control section 4 are formed integrally with each other as a motor-and-pump unit 5.

The steering-force transmitting section 1 mainly includes an input shaft 12, an output shaft 13 and a rack shaft 14. One axial end side of the input shaft 12 is linked to a steering wheel 11 to be able to rotate integrally with the steering wheel 11, so that the input shaft 12 conducts a steering-operation input from the driver. One axial end side of the output shaft 13 is connected coaxially with the input shaft 12 through a torsion bar (not shown) to be able to rotate relative to the input shaft 12. An outer circumference of another axial end side of the output shaft 13 is formed with pinion teeth (not shown). Axially both end portions of the rack shaft 14 are linked with the steerable road wheels. The rack shaft 14 includes rack teeth (not shown) meshing with the pinion teeth, and is movable in its axial direction with a rotation of the output shaft 13. That is, the output shaft 13 rotates to follow the input shaft 12 according to an elastic force of the torsion bar which is generated by turning the steering wheel 11. Then, the rotational motion of the output shaft 13 is converted into a linear motion of the rack shaft 14 by a rack-and-pinion mechanism constructed by the output shaft 13 and the rack shaft 14. Thereby, the rack shaft 14 moves in the axial direction so that the road wheels are turned. It is noted that the rack-and-pinion mechanism corresponds to a steering mechanism according to the present invention.

The steering-force assisting section 2 is constituted by a power cylinder 20. A pair of first and second pressure chambers P1 and P2 are formed separately from each other inside the power cylinder 20. The power cylinder 20 functions to apply a thrust (press) to the rack shaft 14 by means of a difference between hydraulic pressures of the pressure chambers P1 and P2. Thereby, the power cylinder 20 assists the driver with steering force. That is, the power cylinder 20 includes a cylinder tube 21 formed in a substantially circular-tube shape, and a piston 22 fixed to an outer circumference of the rack shaft 14. The rack shaft 14 is passed in an axial direction of the cylinder tube 21, on an inner circumferential side of the cylinder tube 21, i.e., the rack shaft 14 is passed through a hollow portion of the cylinder tube 21 in the axial direction as a rod of the piston 22. Thus, the first and second pressure chambers P1 and P2 are separately defined by the piston 22 and an inner circumferential surface of the cylinder tube 21. The pressure difference between the first and second pressure chambers P1 and P2 produces the thrust of the rack shaft 14 so that the assist of the power cylinder 20 is applied to (i.e., strengthens) the steering output of driver.

The hydraulic-pressure supplying section 3 mainly includes a bidirectional pump (hereinafter, simply referred to as “pump”) 30, a reservoir tank 40, and an electric motor 50. The pump 30 is a reversible pump which supplies hydraulic pressure selectively to the pressure chamber P1 or P2 in accordance with a rotational direction of the steering wheel 11. The pump 30 includes a first supply/exhaust opening 41a and a second supply/exhaust opening 41b which are connected respectively to the first and second pressure chambers P1 and P2 of the power cylinder 20. The reservoir tank 40 is provided on one axial end side of the pump 30, and functions to retain working oil which is used for hydraulic-pressure supply to the pump 30 and the power cylinder 20. The electric motor 50 functions to drive a rotation of the pump 30 in forward and reverse directions. The first supply/exhaust opening 41a is connected through a first pipe passage L1 with the first pressure chamber P1. On the other hand, the second supply/exhaust opening 41b is connected through a second pipe passage L2 with the second pressure chamber P2. It is noted that the first supply/exhaust opening 41a and the second supply/exhaust opening 41b correspond a pair of outlets (first and second outlets) according to the present invention.

A pair of first and second supply/exhaust ports 42a and 42b are provided inside the pump 30. In order to supply/discharge working oil to/from a working chamber (not shown), one of these first and second supply/exhaust ports 42a and 42b functions as a suction port and another of these first and second supply/exhaust ports 42a and 42b functions as a discharge port. The first supply/exhaust port 42a is connected through a first oil passage 43a with the first supply/exhaust opening 41a. On the other hand, the second supply/exhaust port 42b is connected through a second oil passage 43b with the second supply/exhaust opening 41b. The first oil passage 43a is connected through a first suction passage 44a with the reservoir tank 40. On the other hand, the second oil passage 43b is connected through a second suction passage 44b with the reservoir tank 40. A first suction check valve CV1 for preventing a backflow of working oil toward the reservoir tank 40 is provided to the first suction passage 44a. On the other hand, a second suction check valve CV2 for preventing the backflow of working oil toward the reservoir tank 40 is provided to the second suction passage 44b. Accordingly, when working oil becomes insufficient in the first and second pipe passages L1 and L2 and the first and second oil passages 43a and 43b, working oil is fed from the reservoir tank 40 into the first and second pipe passages L1 and L2 and the first and second oil passages 43a and 43b through the opened first and second suction check valves CV1 and CV2.

Moreover, a portion of the first oil passage 43a which is located in a region from a connection portion between the first oil passage 43a and the first suction passage 44a to a connection portion between the first oil passage 43a and the first supply/exhaust opening 41a is connected through a pair of first and second changeover valves BV1 and BV2 (though a connecting oil passage 45) with a portion of the second oil passage 43b which is located in a region from a connection portion between the second oil passage 43b and the second suction passage 44b to a connection portion between the second oil passage 43b and the second supply/exhaust opening 41b. That is, the first oil passage 43a is connected with the second oil passage 43b through the connecting oil passage 45 to which the first and second changeover valves BV1 and BV2 are provided in series with each other. Each of the first and second changeover valves BV1 and BV2 is a so-called normally-closed-type pilot changeover valve. The first changeover valve BV1 operates by using a hydraulic pressure of the second oil passage 43b as its pilot pressure. On the other hand, the second changeover valve BV2 operates by using a hydraulic pressure of the first oil passage 43a as its pilot pressure. The both changeover valves BV1 and BV2 are connected through a drain passage 46 with the reservoir tank 40. The connecting oil passage 45 can communicate with the drain passage 46 via the first or second changeover valve BV1 or BV2. A backpressure regulating valve RV is provided to the drain passage 46. The backpressure regulating valve RV only permits a flow of working fluid (working oil) toward the reservoir tank 40. Thereby, a backflow of working fluid from the reservoir tank 40 is prevented. Also, when a pressure inside the drain passage 46 exceeds a preset pressure value of the backpressure regulating valve RV, working fluid is drained into the reservoir tank 40.

The first and second pipe passages L1 and L2 can be communicated with each other through first and second communication passages 47 and 48 and a third communication passage 49. That is, each of the first and second communication passages 47 and 48 is connected with both of the first and second pipe passages L1 and L2. Then, the third communication passage 49 is connected with both of the first and second communication passages 47 and 48 at first and second connection portions X1 and X2 located at center portions of the communication passages 47 and 48. A so-called normally-open-type solenoid valve (electromagnetic valve) SV is provided to the third communication passage 49. Moreover, a first check valve V1 is provided to the first communication passage 47 in a region between the first pipe passage L1 and the first connection portion X1. This check valve V1 permits a flow of working fluid only in a direction from the first pipe passage L1 toward the first connection portion X1. A second check valve V2 is provided to the first communication passage 47 in a region between the second pipe passage L2 and the first connection portion X1. This check valve V2 permits a flow of working fluid only in a direction from the second pipe passage L2 toward the first connection portion X1. On the other hand, a third check valve V3 is provided to the second communication passage 48 in a region between the first pipe passage L1 and the second connection portion X2. This check valve V3 permits a flow of working fluid only in a direction from the second connection portion X2 toward the first pipe passage L1. A fourth check valve V4 is provided to the second communication passage 48 in a region between the second pipe passage L2 and the second connection portion X2. This check valve V4 permits a flow of working fluid only in a direction from the second connection portion X2 toward the second pipe passage L2. Accordingly, when the solenoid valve SV is opened; working oil inside the first pipe passage L1 can flow through the first check valve V1 and the fourth check valve V4 into the second pipe passage L2 without causing its backflow, and working oil inside the second pipe passage L2 can flow through the second check valve V2 and the third check valve V3 into the first pipe passage L1 without causing its backflow.

That is, the both communication passages 47 and 48, the solenoid valve SV and the respective check valves V1 to V4 constitute a so-called fail safe mechanism. At a normal time, this fail safe mechanism maintains a closed state of the solenoid valve SV so that hydraulic pressures of the pressure chambers P1 and P2 of power cylinder 20 are charged/discharged (adjusted) by the pump 30. On the other hand, when the control section 4 becomes in a failed state, the solenoid valve SV is opened so that the both pressure chambers P1 and P2 of power cylinder 20 communicate with each other through the respective communication passages 47 to 49. Thereby, the hydraulic pressures inside the both pressure chambers P1 and P2 can be directly charged/discharged (directly adjusted by the driver), to ensure a so-called manual steering.

The electric motor 50 is driven and controlled by the control section 4 in accordance with a running state of the vehicle. That is, when the driver conducts a steering manipulation; a rotational direction of the electric motor 50 is changed or maintained in dependence upon a steering direction of this steering manipulation, and also the electric motor 50 is made to control the rotation of pump 30 so as to produce the steering assist torque of the power cylinder 20 according to a steering torque of the driver.

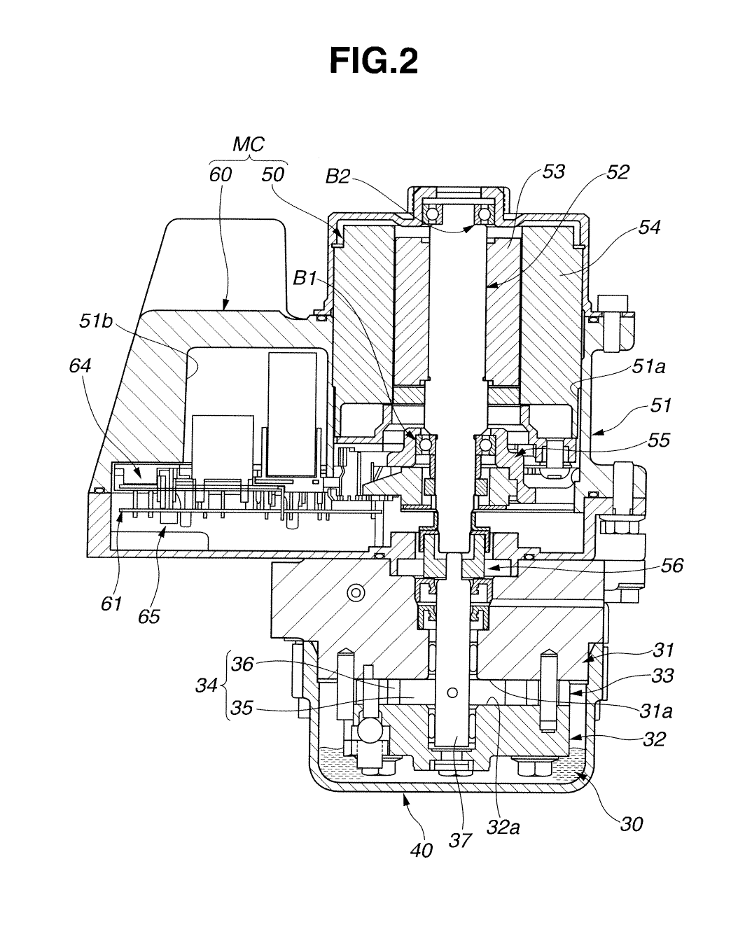

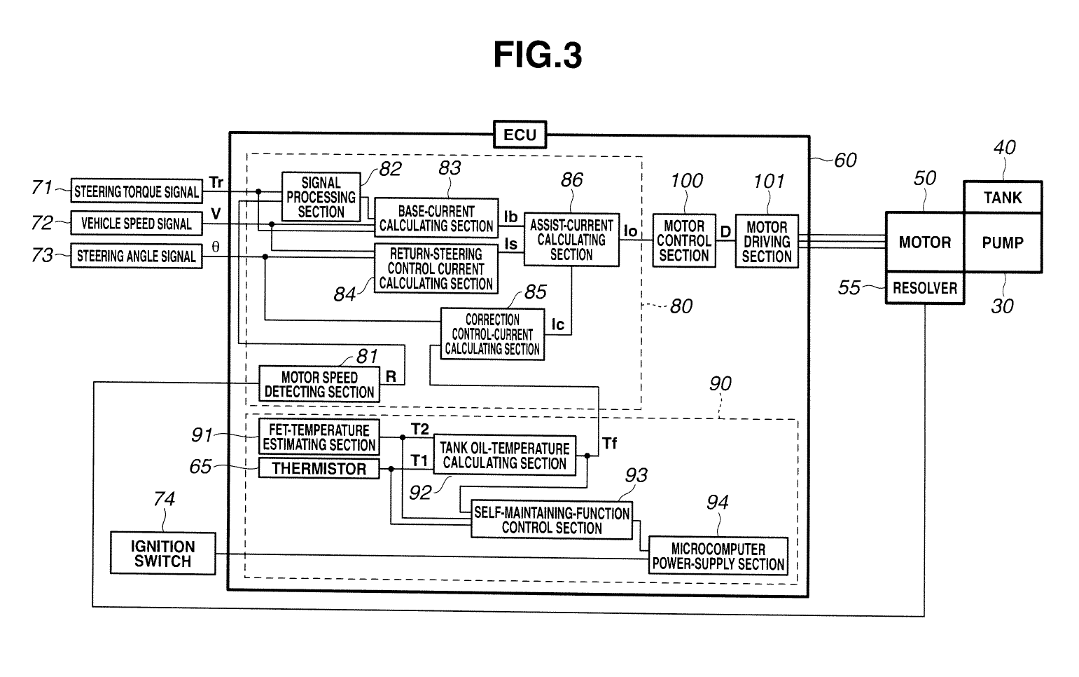

The control section 4 is constituted by a control unit (hereinafter, referred to as ECU) 60. The ECU 60 receives various signals derived from a torque sensor 71, a vehicle-speed sensor(s) 72 (see FIG. 3), a thermistor 65 (see FIGS. 2 and 3), an after-mentioned resolver 55, an engine rotational-speed sensor, and the like. The torque sensor 71 is provided to the input shaft 12. The vehicle-speed sensor 72 is provided to a brake control device arranged at each road wheel (not shown). The thermistor 65 is mounted on an after-mentioned circuit board 61 constituting the ECU 60. On the basis of these various signals, the ECU 60 calculates the steering assist torque and thereby outputs command signals to the electric motor 50 and the solenoid valve SV. It is noted that the control section 4 corresponds to a motor control circuit according to the present invention.

FIG. 2 is a longitudinal cross-sectional view showing an internal structure of the motor-and-pump unit 5.

In the motor-and-pump unit 5; the electric motor 50 is provided on the axially one end side of the pump 30, and the ECU 60 is attached to a lateral portion of the electric motor 50 (i.e., the ECU 60 is arranged in a lateral direction perpendicular to the axial direction of electric motor 50). Moreover, a drive shaft 37 of the pump 30 and an output shaft 52 of the electric motor 50 are connected with each other to be able to rotate integrally with each other, for example, via a predetermined shaft coupling 56 such as Oldham's coupling. In other words, the motor-and-pump unit 5 is a unitized body of the pump 30 and a motor drive device MC, i.e., is obtained by combining the pump 30 with the motor drive device MC as a unit. The motor drive device MC is obtained by combining the ECU 60 integrally with the electric motor 50. On the other hand, on the axially another end side of the pump 30, the reservoir tank 40 is fitted over the axially another end side of the pump 30. The reservoir tank 40 is formed in a substantially cup shape so as to cover the axially another end portion of the pump 30. Thereby, the axially another end portion of the pump 30 is constantly soaked in working oil retained in the reservoir tank 40. Accordingly, the pump 30 can directly suck up the working oil retained in the reservoir tank 40, through the both suction passages 44a and 44b formed to be open from the axially another end portion of pump 30.

The pump 30 is a so-called internal gear pump. The pump 30 includes a pump body 31, a cover member 32, a cam ring 33, and pump elements 34 constituting an internal gear structure of the pump 30. The pump body 31 is formed in a block shape. The cover member 32 is formed in a substantially circular-disc shape. The cam ring 33 is provided to be sandwiched between an inside surface 31a of the pump body 31 and an inside surface 32a of the cover member 32. The pump elements 34 include an inner rotor 35 and an outer rotor 36. The inner rotor 35 has a plurality of outer teeth in its outer circumferential portion, and is fixed to an outer circumference of the drive shaft 37 by press fitting. The outer rotor 36 has a plurality of inner teeth in its inner circumferential portion, and is disposed on an outer circumferential side of the inner rotor 35 to engage the inner teeth of outer rotor 36 with the outer teeth of inner rotor 35. The inner rotor 35 and the outer rotor 36 constituting the pump elements 34 are rotatably arranged on an inner circumferential side of the cam ring 33. By driving the forward or reverse rotation of these pump elements 34 by means of the electric motor 50, hydraulic pressure is selectively supplied to or drained from the pressure chamber P1 or P2 of the power cylinder 20.

The electric motor 50 is a so-called brushless DC motor. The electric motor 50 mainly includes a housing 51, the output shaft 52, a rotor 53, and a stator 54. The housing 51 is fixed to an outside portion of the pump body 31, and serves also as a housing of the ECU 60. That is, the housing 51 constitutes a common casing of both the electric motor 50 and the ECU 60. The output shaft 52 is rotatably supported by a pair of bearings B1 and B2. The pair of bearings B1 and B2 are received and held on an inner circumferential side of a tubular motor receiving portion 51a formed inside the housing 51. The rotor 53 is formed in a substantially circular-tube shape, and is fixed to an outer circumference of the output shaft 52 by press fitting. The stator 54 is formed in a substantially circular-tube shape, and is disposed on an outer circumferential side of the rotor 53 under a noncontact state to keep a predetermined radial clearance between the stator 54 and the rotor 53 (relative to a rotation axis of the output shaft 52). The resolver 55 for detecting a rotational angle of the output shaft 52 is provided on an outer circumference of tip side of the output shaft 52.

The ECU 60 includes the circuit board 61, a microcomputer 62, a nonvolatile RAM (nonvolatile memory) 63, a FET 64, the thermistor 65, and the like. The circuit board 61 is received and accommodated inside an ECU receiving portion 51b provided adjacent to the motor receiving portion 51a inside the housing 51. The microcomputer 62, the nonvolatile RAM 63, the FET 64 and the thermistor 65 are mounted on the circuit board 61. Concrete control configurations of the ECU 60 will be described as follows, referring to FIG. 3.

FIG. 3 is a control block diagram showing details of the control configurations of the ECU60.

The ECU 60 includes an assist-current command section 80, a tank oil-temperature estimating section 90, a motor control section 100, and a motor driving section 101. The assist-current command section 80 calculates the steering assist torque on the basis of a steering torque signal Tr, a vehicle speed signal V, an after-mentioned tank oil-temperature signal Tf and the like. Thereby, the assist-current command section 80 outputs an after-mentioned assist current Io for controlling a drive of the electric motor 50. The tank oil-temperature estimating section 90 estimates a temperature of working oil inside the reservoir tank 40. The motor control section 100 controls the drive of the electric motor 50 on the basis of the assist current Io. The motor driving section 101 drives the electric motor 50 on the basis of an after-mentioned drive signal D outputted from the motor control section 100.

The assist-current command section 80 includes a motor rotational-speed detecting section 81, a signal processing section 82, a base-current calculating section 83, a return-steering control current calculating section 84, a correction control-current calculating section 85, and an assist-current calculating section 86. The motor rotational-speed detecting section 81 detects (estimates) a rotational speed R of the electric motor 50. The signal processing section 82 performs a predetermined processing such as a noise rejection, for the steering torque signal Tr outputted from the torque sensor 71. The base-current calculating section 83 calculates a base current Ib for producing a base assist torque which serves as a base for the steering assist torque, on the basis of the steering torque signal Tr outputted from the signal processing section 82 and the vehicle speed signal V outputted from the vehicle-speed sensor 72. The return-steering control current calculating section 84 calculates a return-steering control current Is for producing assist torque for an after-mentioned return-steering control, on the basis of the vehicle speed signal V outputted from the vehicle-speed sensor 72 and a steering angle signal θ outputted from a steering angle sensor 73. The correction control-current calculating section 85 calculates a correction control current Ic for an after-mentioned torque correction control, on the basis of the steering angle signal θ outputted from the steering angle sensor 73 and the tank oil-temperature signal Tf outputted from an after-mentioned tank oil-temperature calculating section 92. The assist-current calculating section 86 calculates the assist current Io for controlling the drive of electric motor 50, on the basis of the base current Ib, the return-steering control current Is and the correction control current Ic. It is noted that the base-current calculating section 83 corresponds to a base-current command value calculating circuit according to the present invention, the assist-current calculating section 86 corresponds to a corrected-current command-value calculating circuit according to the present invention, the base current Ib corresponds to a current command value according to the present invention, and the assist current Io corresponds to a corrected-current command value according to the present invention.

The motor rotational-speed detecting section 81 detects the actual rotational speed R of the electric motor 50, on the basis of information of rotational position of the output shaft 52 which is outputted from the resolver 55. Then, the motor rotational-speed detecting section 81 outputs the detected actual rotational speed R to the signal processing section 82. In this embodiment, the correction control current Ic is calculated by use of a steering angular speed (angular velocity) ω having a correlation with a flow speed of working oil, as will be explained below. However, according to the present invention, the correction control current Ic may be calculated by use of the actual rotational speed R. That is, in detail, the actual number of revolutions per unit time of the pump 30 is calculated from the actual rotational speed R of electric motor 50. Then, the actual number of revolutions per unit time of the pump 30 is multiplied by an intrinsic discharge amount (fixed value) of the pump 30, and thereby, a discharge rate of the pump 30 having a certain correlation with the flow speed of working oil can be obtained. Therefore, the correction control current Ic can be calculated by use of the actual number of revolutions per unit time (the actual rotational speed R) of the electric motor 50. In this case, the actual rotational speed R of the electric motor 50 can be detected easily. Hence, also in this case, in the same manner as the case that the correction control current Ic is calculated by use of the steering angular speed ω, a simplification of the apparatus and a reduction of manufacturing cost can be attained as compared with the case that the flow speed of working oil is directly detected.

The signal processing section 82 performs a noise processing and a phase compensation processing for the steering torque signal Tr which is used for calculating the base current Ib in the base-current calculating section 83. That is, the signal processing section 82 removes noises of the steering torque signal Tr and compensates for a phase delay due to a transmission system of assist torque, a motor inertia and the like, by applying a predetermined filtering process to the steering torque signal Tr outputted from the torque sensor 71. Thereby, the signal processing section 82 outputs the steering torque signal Tr which has become appropriate for the calculation of base current Ib, to the base-current calculating section 83.

The base-current calculating section 83 calculates the base assist torque referring to a predetermined map (not shown), on the basis of the steering torque signal Tr outputted from the signal processing section 82 and the vehicle speed signal V outputted from the vehicle-speed sensor 72. Then, the base-current calculating section 83 calculates the base current Ib for generating the base assist torque, and outputs the base current Ib to the assist-current calculating section 86. In this predetermined map, the base current Ib is substantially set to becomes greater as the steering torque Tr becomes larger or as the vehicle speed V becomes lower.

The return-steering control current calculating section 84 calculates a return-steering assist torque when the steering wheel 11 is manipulated (turned) in a return direction, on the basis of the vehicle speed signal V outputted from the vehicle-speed sensor 72 and the steering angle signal θ outputted from the steering angle sensor 73, referring to a predetermined map (not shown). Then, the return-steering control current calculating section 84 calculates the return-steering control current Is for producing the return-steering assist torque, and outputs return-steering control current Is to the assist-current calculating section 86.

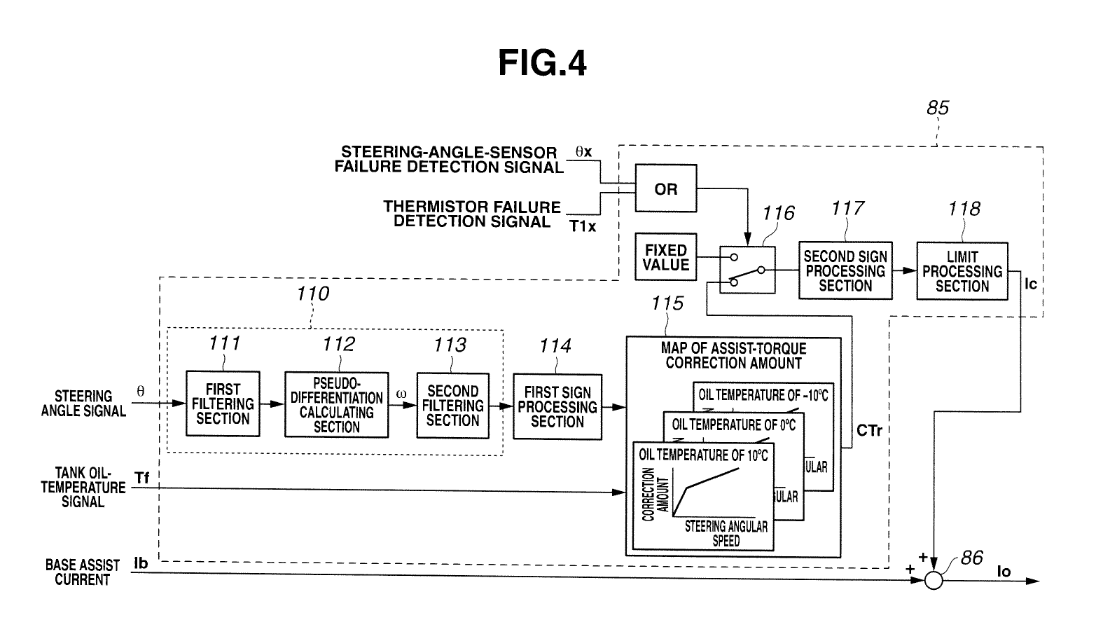

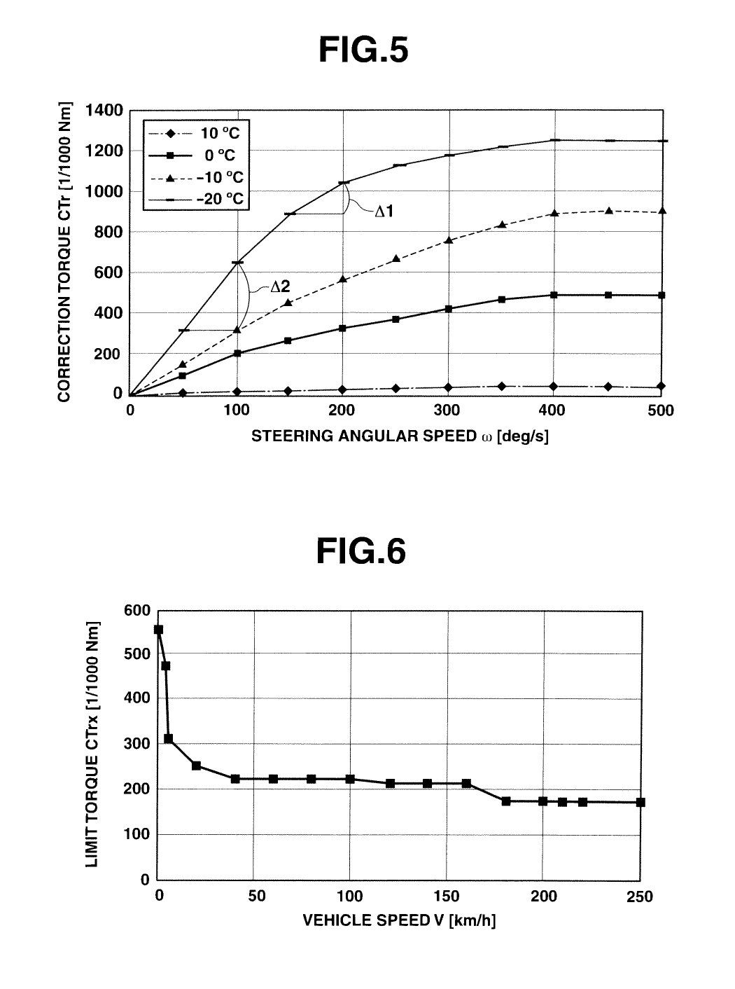

The correction control-current calculating section 85 calculates a correction torque CTr on the basis of the steering angle signal θ outputted from the steering angle sensor 73 and the tank oil-temperature signal Tf outputted from the tank oil-temperature calculating section 92, with reference to a correction torque map as shown FIG. 5. Then, the correction control-current calculating section 85 calculates the correction control current Ic for producing the correction torque CTr, and outputs the correction control current Ic to the assist-current calculating section 86. Concrete processing contents in the correction control-current calculating section 85 will be described below in detail, referring to FIGS. 4 to 7. It is noted that the steering angle sensor 73 corresponds to a flow-speed detecting section (or means) and a steering-speed detecting section (or means) according to the present invention.

The assist-current calculating section 86 calculates the assist current Io by adding the correction control current Ic outputted from the correction control-current calculating section 85 and the return-steering control current Is outputted from the return-steering control current calculating section 84, to the base current Ib outputted from the base-current calculating section 83. Then, the assist-current calculating section 86 outputs the assist current Io to the motor control section 100. Thus in this embodiment, since the assist current Io is calculated by using the sum of the base current Ib and the correction control current Ic, the base current Ib itself is not changed. That is, a characteristic of the above-mentioned predetermined map for calculating the base current Ib does not need to be changed. Hence, there is no risk that a characteristic of steering assist torque relative to the steering torque of driver is greatly varied. As a result, a strangeness feeling of steering such as an excessively light-steering feeling can be suppressed.

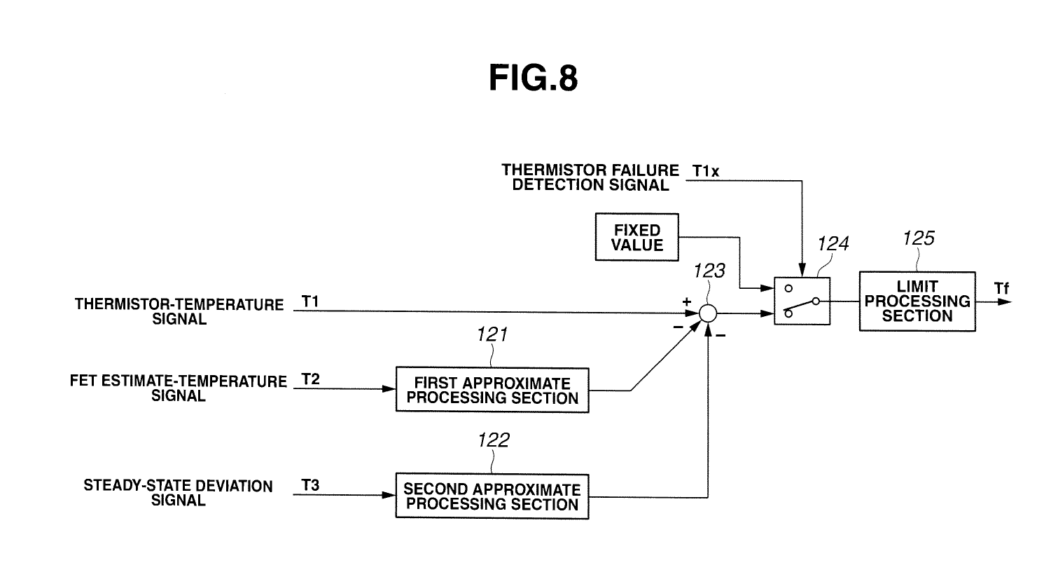

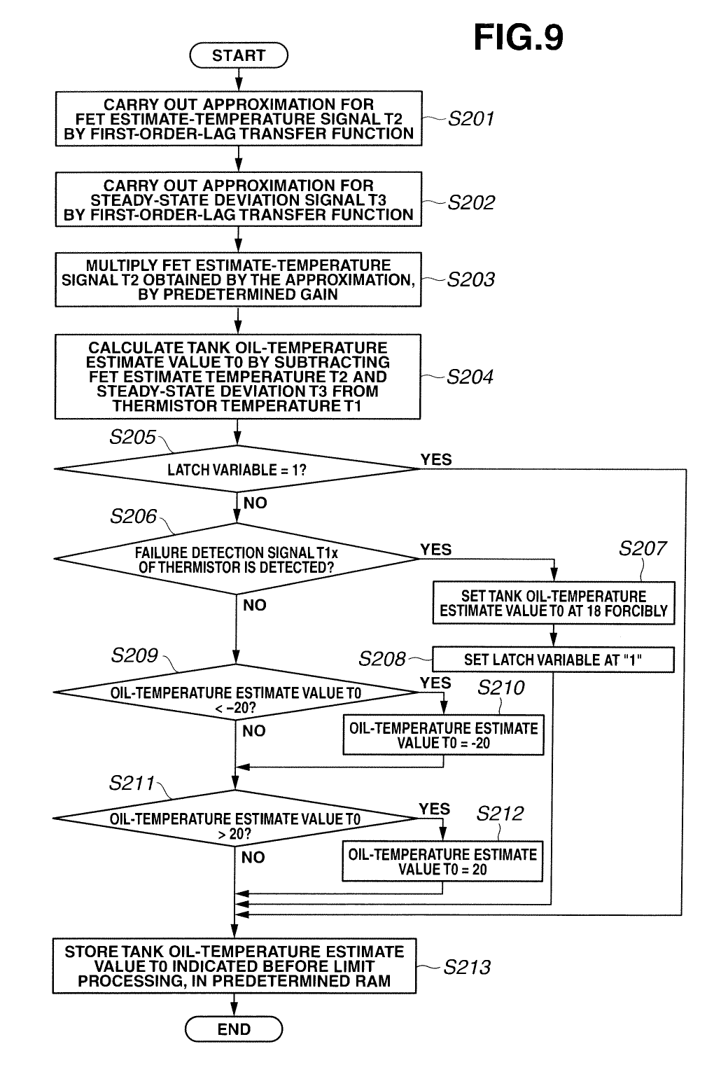

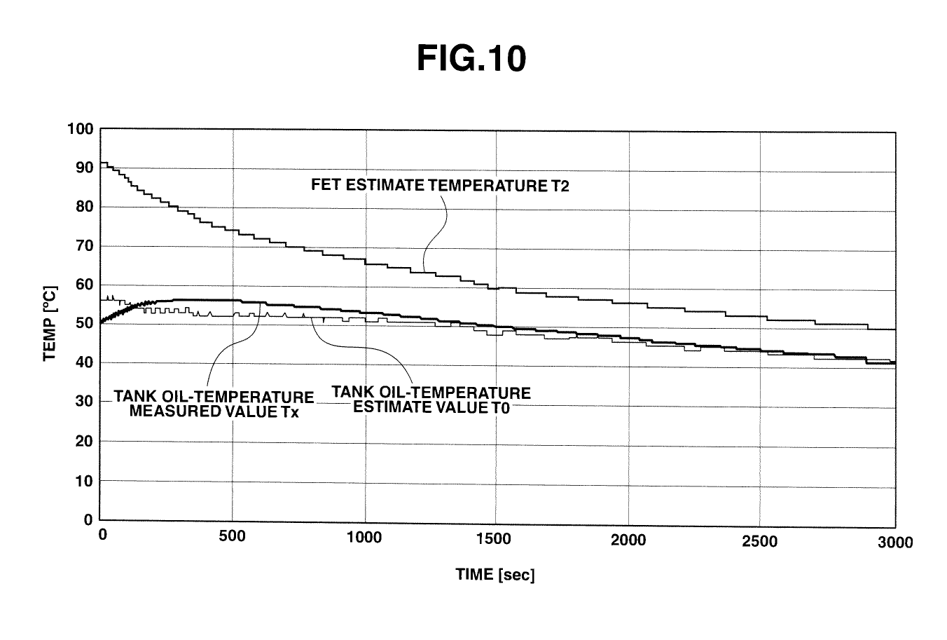

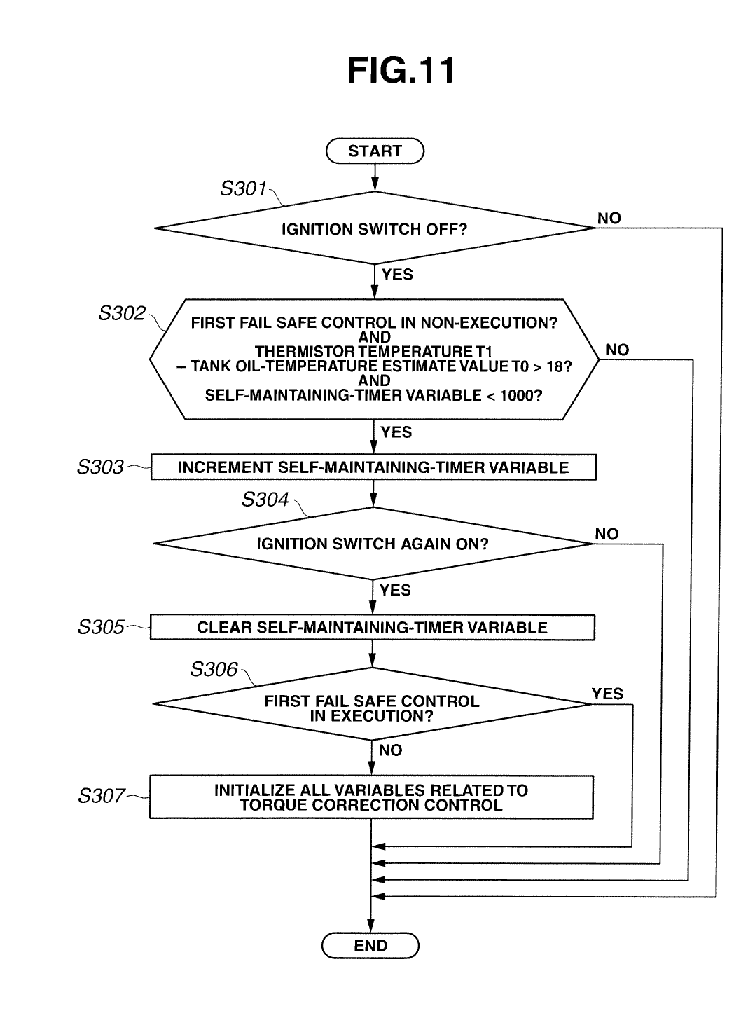

The tank oil-temperature estimating section 90 includes a FET-temperature estimating section 91, the thermistor (temperature sensor) 65, the tank oil-temperature calculating section 92, a self-maintaining-function control section 93 and a microcomputer power-supply section 94. The FET-temperature estimating section 91 estimates a heating temperature of the FET 64. The thermistor 65 detects an ambient temperature inside the ECU 60. The tank oil-temperature calculating section 92 calculates a tank oil-temperature estimate value T0 on the basis of a FET estimate-temperature signal T2 outputted from the FET-temperature estimating section 91 and a thermistor-temperature signal T1 (the ambient so temperature) outputted from the thermistor 65. The microcomputer power-supply section 94 activates and shuts off a power supply to the microcomputer 62. The self-maintaining-function control section 93 controls the microcomputer power-supply section 94, and thereby, continues to calculate the tank oil-temperature estimate value T0 until a predetermined time period has elapsed after an ignition switch 74 was turned off. Detailed concrete contents about the tank oil-temperature calculating section 92 will be described later referring to FIGS. 8 and 9. Detailed concrete contents about the self-maintaining-function control section 93 will be described later mainly referring to FIGS. 10 and 11. It is noted that the thermistor 65 corresponds to a fluid temperature detecting section (or means) according to the present invention, and the thermistor-temperature signal T1 corresponds a correction-purpose temperature signal according to the present invention.

The motor control section 100 receives a rotational position information of the electric motor 50 detected by the motor rotational-speed detecting section 81 and an information of respective U-phase, V-phase and W-phase currents which is derived from a current sensor (not shown) interposed between the after-mentioned motor driving section 101 and the electric motor 50. Then, the motor control section 100 transforms the three of U-phase, V-phase and W-phase currents into two-phase currents. Then, the motor control section 100 produces the drive signal (PWM signal) D for the electric motor 50 by a feedback control such as a so-called P-I control, and then, outputs the PWM signal D to the motor driving section 101.

The motor driving section 101 is constituted by power elements including the FET(s) 64. The motor driving section 101 supplies a control current corresponding to the assist current Io to the electric motor 50, by switching the power elements according to the PWM signal derived from the motor control section 100.

The concrete control contents of the correction control-current calculating section 85 will now be explained referring to FIGS. 4 to 7.

FIG. 4 is a system diagram showing a calculation progress for the correction control current Ic in the correction control-current calculating section 85. FIG. 5 is a graph showing the correction torque CTr relative to the steering angular speed ω, for several values of the tank oil temperature Tf. That is, FIG. 5 is a correction torque map which is used for calculating the correction control current Ic. FIG. 6 is a graph showing an after-mentioned limit torque CTrx relative to the vehicle speed V. That is, FIG. 6 is a limit torque map for an after-mentioned limit processing for the correction control current Ic.

As shown in FIG. 4, the correction control-current calculating section 85 includes a steering-angular-speed calculating section 110, a first sign processing section 114, a correction-torque calculating section 115, a switch 116, a second sign processing section 117, and a limit processing section 118. The steering-angular-speed calculating section 110 calculates the steering angular speed ω based on the steering angle signal θ. The first sign processing section 114 conducts a sign processing of the steering angular speed ω outputted from the steering-angular-speed calculating section 110. The correction-torque calculating section 115 calculates the correction torque CTr from the correction torque map as shown in FIG. 5, on the basis of the steering angular speed ω processed by the first sign processing section 114 and the tank oil-temperature signal Tf outputted from the tank oil-temperature estimating section 90. The switch 116 switches between ON and OFF of the correction torque CTr which is outputted as the correction control current Ic, in accordance with a state (normal state/abnormal state) of each of the steering angle sensor 73 and the thermistor 65. The second sign processing section 117 conducts a sign processing of the correction control current Ic outputted through the switch 116. The limit processing section 118 applies the so-called limit processing to the correction control current Ic processed by the second sign processing section 117, based on the limit torque map as shown in FIG. 6.

According to the present invention, the correction control current Ic can be calculated based on the working-oil temperature (the tank oil temperature Tf) inside the reservoir tank 40 and the flow speed of working oil or the steering angular speed ω. In this embodiment, for convenience sake of control, the correction control current Ic is calculated based on the tank oil temperature so Tf and the steering angular speed ω having a certain correlation (proportional relation) with the flow speed of working fluid. For reference, as a method of estimating the flow speed of working oil from the steering angular speed ω, for example, the flow speed of working oil can be estimated based on a working-fluid amount moved between the both pressure chambers P1 and P2 which is obtained by multiplying a cross-sectional area of the piston 22 of power cylinder 20 by a moving speed of the piston 22 given based on the steering angular speed ω.

The steering-angular-speed calculating section 110 includes a first filtering section 111, a pseudo-differentiation calculating section 112 and a second filtering section 113. The first filtering section 111 is a filter circuit for performing the noise removal of the steering angle signal θ by applying a filtering using a predetermined low-pass filter to the steering angle signal θ derived from the steering angle sensor 73. The pseudo-differentiation calculating section 112 calculates the steering angular speed ω by applying a pseudo differentiation to the steering angle signal θ obtained by the filtering of the first filtering section 111. The second filtering section 113 is a filter circuit for performing a noise removal of the steering angular speed ω obtained by the pseudo differentiation processing, by applying a filtering using the predetermined low-pass filter same as the first filtering section 111 to the steering angular speed ω calculated by the pseudo-differentiation calculating section 112.

Thus, in the steering-angular-speed calculating section 110, the steering angle signal θ derived from the steering angle sensor 73 is not directly used for calculating the steering angular speed ω. Instead, the steering angular speed ω is calculated by using the signal which is obtained by applying the above-mentioned predetermined filtering to the steering angle signal θ derived from the steering angle sensor 73. Moreover, the above-mentioned predetermined filtering is again applied to the calculated steering angular speed ω. Accordingly, for example, an unintentional change of the steering angular speed ω (steering angle signal θ) at the time of kickback from a road surface and the like and an abrupt change of the steering angular speed ω at the time of abrupt turning (steering) and the like are not directly reflected (included) in an after-mentioned calculation of the correction torque CTr. Therefore, a rapid variation of the correction torque CTr is suppressed to improve a steering feeling of the driver.

The first sign processing section 114 takes an absolute value of the steering angular speed ω outputted from the steering-angular-speed calculating section 110, for convenience sake of a processing of the correction-torque calculating section 115. At the same time, the first sign processing section 114 stores (saves) a sign information of the steering angular speed ω in a sign shelter RAM (not shown). Specifically, the first sign processing section 114 stores “1” in the sign shelter RAM if the steering angular speed ω outputted from the steering-angular-speed calculating section 110 is a positive value. On the other hand, the first sign processing section 114 stores “0” in the sign shelter RAM if the steering angular speed ω outputted from the steering-angular-speed calculating section 110 is a negative value.

The correction-torque calculating section 115 calculates the correction torque CTr from the correction torque map as shown in FIG. 5 by means of so-called linear interpolation, on the basis of the absolute value of the steering angular speed ω derived from the first sign processing section 114 and the tank oil-temperature signal Tf derived from the tank oil-temperature estimating section 90.

As shown in FIG. 5, in the correction torque map, the correction torque CTr (correction control current Ic) is set to become larger as the steering angular speed ω correlated with the flow speed of working oil becomes higher, and is set to become larger as the tank oil-temperature signal Tf correlated with a viscosity of working oil becomes lower. Thus, as the steering angular speed ω becomes higher or as the tank oil-temperature signal Tf becomes lower, the assist current Io to be finally outputted to the electric motor 50 becomes greater.

In this correction torque map, as shown in FIG. 5, a first rate Δ1 is set to be smaller than a second rate Δ2. The first rate Δ1 is defined by an increased amount of the correction torque CTr relative to an increased amount of the steering angular speed ω (Increased amount of correction torque CTr/Increased amount of steering angular speed ω) in a region higher than or equal to a predetermined speed value (e.g., 100 deg/s) of the steering angular speed ω under a constant condition (e.g., −20° C.) of the tank oil-temperature signal Tf (tank oil-temperature estimate value T0). The second rate Δ2 is defined by an increased amount of the correction torque CTr relative to an increased amount of the steering angular speed ω in a region lower than the predetermined speed value (e.g., 100 deg/s) of the steering angular speed ω under the same condition (e.g., −20° C.) of the tank oil-temperature signal Tf. That is, a boundary characteristic between working oil and inner wall surfaces of the first and second oil passages 43a and 43b of pump 30 and the first and second pipe passages L1 and L2 is varied according to the steering angular speed ω (flow speed of working oil). Hence, in this embodiment, the increased amount of the correction torque CTr is set according to this change of boundary characteristic. Therefore, an occurrence of strangeness feeling of steering (for example, excessive light steering) can be suppressed. In other words, the correction torque CTr is not increased in proportion to the variation of the steering angular speed ω (flow speed of working oil), but instead, the increased amount of the correction torque CTr is made to be smaller as the steering angular speed ω (flow speed of working oil) becomes higher. Thereby, a strangeness feeling of steering can be suppressed which is caused to the driver because the correction torque CTr becomes excessively large to excessively lighten the steering when the steering angular speed ω (flow speed of working oil) is high.

Moreover, in this correction torque map, a reduction rate of the first rate Δ1 relative to the second rate Δ2 is set to be larger as the tank oil-temperature signal Tf (working oil temperature) becomes lower. That is, a rate (Δ1/Δ2) of the first rate Δ1 to the second rate Δ2 is smaller as the tank oil-temperature signal Tf becomes lower. The boundary characteristic between working oil and the inner wall surfaces of the first and second oil passages 43a and 43b of pump 30 and the first and second pipe passages L1 and L2 which is varied nonlinearly according to the flow speed of working oil as mentioned above is varied also according to the tank oil-temperature signal Tf (working oil temperature). Hence, in this embodiment, the increased amount of the correction torque CTr is set according to this change of boundary characteristic, i.e., according to the tank oil-temperature signal Tf. Therefore, a strangeness feeling of steering can be suppressed which is caused, for example, because the correction torque CTr becomes excessive large to excessively lighten the steering when the tank oil-temperature signal Tf (working oil temperature) is high.

The switch 116 outputs the correction control current Ic on the basis of a failure detection signal θx derived from the steering angle sensor 73 and a failure detection signal T1x derived from the thermistor 65. That is, the switch 116 outputs the correction torque CTr derived from the correction-torque calculating section 115 if both of the sensors (sensing means) 73 and 65 are normal (not failed). On the other hand, the switch 116 outputs a fixed value of “0” if at least one of the steering angle sensor 73 and the thermistor 65 is in an abnormal state (failed state). That is, when the steering angle sensor 73 and the thermistor 65 are in the normal state, the above-mentioned torque correction control is performed. On the other hand, when the steering angle sensor 73 or the thermistor 65 is in the abnormal state, the above-mentioned torque correction control is not performed as a so-called fail safe control (hereinafter, referred to as first fail safe control). At this time, an information about the failure detection signal θx derived from the steering angle sensor 73 and the failure detection signal T1x derived from the thermistor 65 is stored in a predetermined RAM (not shown). Specifically, in the case of normal state, a latch variable of the predetermined RAM is set at “0”. On the other hand, in the case of abnormal state, the latch variable of the predetermined RAM is set at “1”, and thereby, the first fail safe control is maintained when the ignition switch is in ON state.

Thus, the above-mentioned torque correction control is not carried out in the case that the failure has been detected in the steering angle signal θ obtained by the steering angle sensor 73 and in the thermistor-temperature signal T1 obtained by the thermistor 65. Accordingly, a problem can be suppressed that the torque correction control adversely affects the steering feeling.

The second sign processing section 117 functions to reactivate the sign stored by the first sign processing section 114. That is, if the sign shelter RAM used by the first sign processing section 114 is maintaining “0”, the second sign processing section 117 applies a negative sign to the correction torque CTr outputted from the correction-torque calculating section 115 (i.e., the correction torque CTr is multiplied by −1).

The limit processing section 118 performs an upper-limit restriction processing for the correction torque CTr with reference to a limit torque map as shown in FIG. 6. That is, the upper-limit restriction processing is carried out to prevent the correction torque CTr outputted from the correction-torque calculating section 115 from exceeding a predetermined upper-limit value (limit torque CTrx). In this embodiment, since such a limit processing is carried out, the correction control current Ic does not exceed its permissible upper limit even if the correction torque CTr has been calculated as an excessively large value. Accordingly, the strangeness feeling of steering which is caused, for example, due to the steering excessively lightened by the correction control can be suppressed.

As shown in FIG. 6, in the limit torque map, the limit torque CTrx functioning as the upper-limit value is set to be lower as the vehicle speed V becomes higher. That is, as the vehicle speed V becomes higher; a magnitude of necessary steering assist torque becomes smaller, and the strangeness feeling of steering due to excessively large steering assist torque becomes greater. Hence, in this embodiment, the limit torque CTrx is set according to the vehicle speed V. Thereby, the steering assist torque can be inhibited from being set excessively high at the time of high vehicle speed, while a steering load at the time of low vehicle speed can be reduced.

The correction control-current calculating section 85 includes a vehicle-speed receiving section (not shown) which receives the vehicle speed signal V from the vehicle-speed sensor 72. The above-mentioned limit processing is performed based on the vehicle speed signal V inputted to this vehicle-speed receiving section.

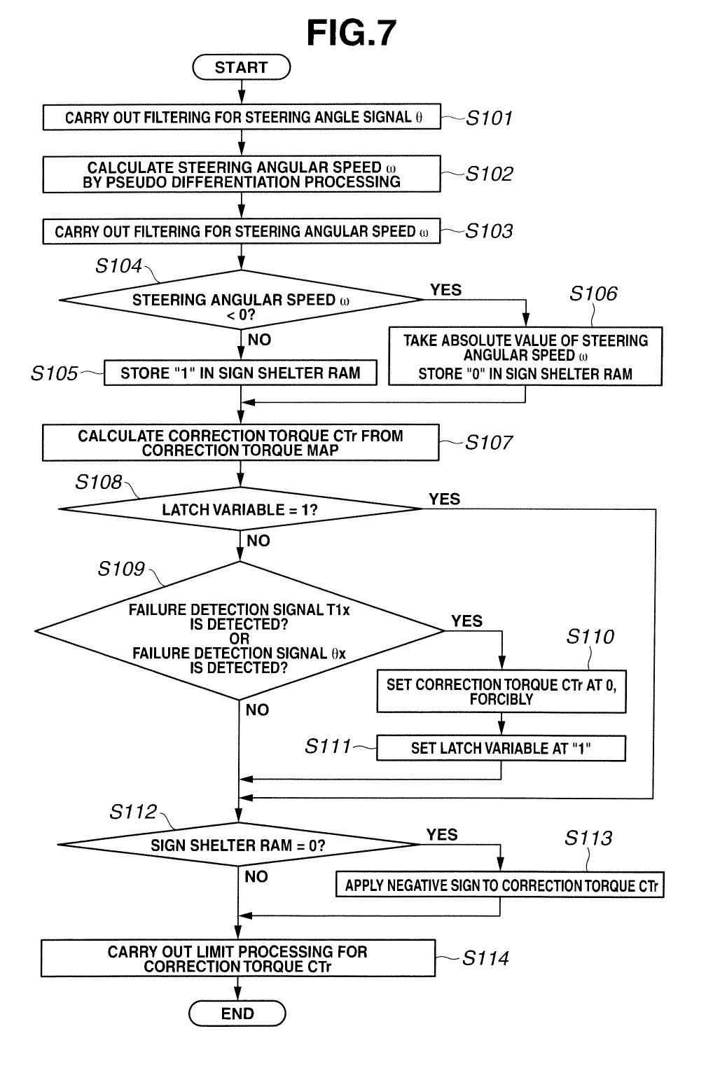

A control flow in the correction control-current calculating section 85 configured as mentioned above will now be explained referring to FIG. 7.

FIG. 7 is a flowchart showing the control flow in the correction control-current calculating section 85.

In the correction control-current calculating section 85, at first, the filtering using the predetermined low-pass filter is carried out for the steering angle signal θ outputted from the steering angle sensor 73 at step S101. Then, at step S102, the pseudo differentiation processing is carried out for the steering angle signal θ obtained by the filtering of step S101, so that the steering angular speed ω is calculated. Then, at step S103, the filtering using the predetermined low-pass filter is carried out again for the steering angular speed ω obtained by the differentiation processing of step S102.

Then, at step S104, it is judged whether the steering angular speed ω obtained by the filtering of step S103 is a positive value or a negative value. If the sign of the steering angular speed ω is positive, “1” is stored in the sign shelter RAM at step S105. On the other hand, if the sign of the steering angular speed ω is negative, “0” is stored in the sign shelter RAM at step S106 while the absolute value of the steering angular speed ω is calculated. Then, at step S107, the correction torque CTr is calculated based on the steering angular speed ω obtained by the sign processing of step S105 or 106, from the correction torque map (see FIG. 5).

Then, at step S108, it is judged whether or not the latch variable of the predetermined RAM is equal to “1”, i.e., it is judged whether or not the first fail safe control is being carried out (in execution). If the latch variable is equal to “0”, i.e., if the first fail safe control is not in execution; the program proceeds to step S109. If the latch variable is equal to “1” at step S108, i.e., if the first fail safe control is in execution; the program proceeds to step S112. At step S109, it is judged whether or not the failure detection signal T1x of the thermistor 65 is detected. Moreover, at step S109, it is judged whether or not the failure detection signal θx of the steering angle sensor 73 is detected. If at least one of the failure detection signal T1x and the failure detection signal θx is detected at step S109, the program proceeds to step S110. At step S110, the switch 116 sets the correction torque CTr at 0, and outputs the correction torque CTr equal to 0. Then, the program proceeds to step S111. At step S111, the latch variable of the predetermined RAM is set at “1”.

Subsequent to steps S108, S109 or S111, at step S112, it is judged whether or not the sign shelter RAM maintains “0”, namely, it is judged whether or not the stored sign is negative. If the sign shelter RAM is maintaining “1”, namely if the stored sign is positive; the program proceeds to step S114. On the other hand, if the sign shelter RAM is maintaining “0”, namely if the stored sign is negative; the program proceeds to step S113. At step S113, the negative sign is applied to the correction torque CTr. That is, the sign recovery processing is carried out at step S113, and then, the program proceeds to step S114. At step S114, the limit processing about the correction torque CTr is carried out. Then, the control flow of the correction control-current calculating section 85 is ended.

Next, concrete control contents of the tank oil-temperature calculating section 92 will now be explained referring to FIGS. 8 and 9.

FIG. 8 is a system diagram showing a calculation progress for the tank oil-temperature signal Tf in the tank oil-temperature calculating section 92.

The tank oil-temperature calculating section 92 includes a first approximate processing section 121, a second approximate processing section 122, an adder 123, a switch 124 and a limit processing section 125. The first approximate processing section 121 performs an approximate processing (approximation) for the FET estimate-temperature signal T2 outputted from the FET-temperature estimating section 91, by a predetermined first-order-lag transfer function (time constant: 0.00023 [Hz]). The second approximate processing section 122 performs an approximate processing for a steady-state deviation signal T3 by a predetermined first-order-lag transfer function (time constant: 0.00167 [Hz]). The steady-state deviation signal T3 is an alienation (divergence) between the temperature of the thermistor 65 and the working-oil temperature inside the reservoir tank 40, which has been previously calculated by experiments. That is, the steady-state deviation signal T3 corresponds to a heating value caused by an energization of the ECU 60. The adder 123 calculates the tank oil-temperature estimate value T0 by subtracting the FET estimate-temperature signal T2 and the steady-state deviation signal T3 from the thermistor-temperature signal T1 outputted from the thermistor 65. The switch 124 switches between ON and OFF of the tank oil-temperature estimate value T0 to be outputted, in accordance with a state (normal state/abnormal state) of the thermistor 65. The limit processing section 125 performs a so-called limit processing for the tank oil-temperature estimate value T0 outputted through the switch 124.

In the power steering apparatus according to this embodiment, the tank oil-temperature estimate value T0 which is used for calculating the correction control current Ic is estimated by subtracting the FET estimate temperature T2 and the steady-state deviation T3 (which is a fixed value equal to 18° C. in this embodiment) from the thermistor temperature T1. The FET estimate temperature T2 corresponds to a heating temperature of the FET 64. The steady-state deviation T3 corresponds to a heating temperature of the microcomputer 62, an ASIC and like. Accordingly, the tank oil-temperature estimate value T0 can be estimated with a higher accuracy. That is, since the FET 64, the microcomputer 62 and the like which are heating sources have been mounted on the circuit board 61 of the ECU 60, the thermistor-temperature signal T1 outputted from the thermistor 65 includes a heating quantity by the FET 64, the microcomputer 62 and the like. On the other hand, working oil inside the reservoir tank 40 is little influenced by the heating of the FET 64, the microcomputer 62 and the like. Therefore, the tank oil-temperature estimate value T0 can be estimated with a high accuracy by subtracting the FET estimate temperature T2 and the steady-state deviation T3 from the thermistor temperature T1 as mentioned above.

The switch 124 operates based on the failure detection signal T1x derived from the thermistor 65. That is, the switch 124 outputs the tank oil-temperature estimate value T0 outputted from the adder 123, if the thermistor 65 is in a normal state (not-failed state). If the thermistor 65 is in an abnormal state (failed state); the switch outputs a predetermined temperature value which is a backup fixed value equal to 18° C., as the tank oil-temperature signal Tf. Accordingly, when the thermistor 65 is in the normal state, the correction control is performed based on the tank oil-temperature estimate value T0 estimated as above. On the other hand, when the thermistor 65 is in the abnormal state, the correction control based on working-oil temperature inside the reservoir tank 40 is not performed as a so-called fail safe (hereinafter, referred to as second fail safe control). At this time, an information of the failure detection signal T1x derived from the thermistor 65 is stored in a predetermined RAM (not shown). That is, in the case of normal state, a latch variable of this predetermined RAM is set at “0”. On the other hand, in the case of abnormal state, the latch variable of this predetermined RAM is set at “1”. Thereby, the second fail safe control is maintained while the ignition switch is in ON state.

Thus, when the thermistor-temperature signal T1 detected by the thermistor 65 is in the abnormal state; the steering assist torque is calculated by using the fixed value (backup temperature) provided by experiments and the like in advance, i.e., without the correction control based on the tank oil-temperature signal Tf (tank oil-temperature estimate value T0). Accordingly, a problem can be suppressed that the torque correction control adversely affects the steering feeling.

The limit processing section 125 carries out a limit processing as to upper and lower limits of the tank oil-temperature estimate value T0 outputted through the switch 124. That is, the limit processing section 125 carries out a limit processing to bring the tank oil-temperature estimate value T0 into a range between −20° C. and 20° C. Hence, if the tank oil-temperature estimate value T0 outputted through the switch 124 is lower than −20° C., the limit processing section 125 outputs the value of −20° C. On the other hand, if the tank oil-temperature estimate value T0 outputted through the switch 124 is higher than 20° C., the limit processing section 125 outputs the value of 20° C.

A control flow of the tank oil-temperature calculating section 92 configured as above will now be explained referring to FIG. 9.

FIG. 9 is a flowchart showing the control flow of the tank oil-temperature calculating section 92.

In the tank oil-temperature calculating section 92, at first, the approximate processing for the FET estimate-temperature signal T2 outputted from the FET-temperature estimating section 91 is carried out by the above-mentioned predetermined first-order-lag transfer function at step S201. Then, at step S202, the approximate processing for the steady-state deviation signal T3 stored in advance is carried out by the above-mentioned predetermined first-order-lag transfer function. Then, at step S203, the FET estimate-temperature signal T2 obtained by the approximate processing of step S201 is multiplied by a predetermined gain in order to complete the approximate processing of step S201. Then, at step S204, the FET estimate-temperature signal T2 and the steady-state deviation signal T3 obtained by the above respective processing are subtracted from the thermistor-temperature signal T1, so that the tank oil-temperature estimate value T0 is calculated.

Then, at step S205, it is judged whether or not the latch variable of the predetermined RAM is equal to “1”, i.e., it is judged whether or not the second fail safe control is in execution. If the latch variable is equal to “0”, namely if the second fail safe control is not in execution; the program proceeds to step S206. On the other hand, if the latch variable is equal to “1”, namely if the second fail safe control is in execution; the program proceeds to step S213. At step S206, it is judged whether or not the failure detection signal T1x of the thermistor 65 is detected.

If the failure detection signal T1x of the thermistor 65 is detected at step S206, the program proceeds to step S207. At step S207, the tank oil-temperature estimate value T0 is changed to the fixed value equal to 18° C. by the switch 124, and then, the program proceeds to step S208. At step S208, the latch variable of the predetermined RAM is set at “1”.

If the failure detection signal T1x of the thermistor 65 is not detected at step S206, the program proceeds to step S209. At step S209, it is judged whether or not the tank oil-temperature estimate value T0 is lower than −20° C. If the tank oil-temperature estimate value T0 is higher than or equal to −20° C., the program proceeds to step S211. If the tank oil-temperature estimate value T0 is lower than −20° C., the program proceeds to step S210. At step S210, the tank oil-temperature estimate value T0 is changed to −20° C., and then, the tank oil-temperature signal Tf is outputted.

At step S211, it is judged whether or not the tank oil-temperature estimate value T0 is higher than 20° C. If the tank oil-temperature estimate value T0 is lower than or equal to 20° C., the program proceeds to step S213. If the tank oil-temperature estimate value T0 is higher than 20° C., the program proceeds to step S212. At step S212, the tank oil-temperature estimate value T0 is changed to 20° C., and then, the tank oil-temperature signal Tf is outputted.

At step S213, the value of tank oil-temperature estimate value T0 indicated before receiving this limit processing is stored in a predetermined RAM for monitoring the tank oil-temperature estimate value T0. Then, the control flow of the tank oil-temperature calculating section 92 is ended.

Next, an overview of the self-maintaining-function control section 93 will now be explained. FIG. 10 is a view showing respective transitions of the tank oil-temperature estimate value T0, the FET estimate temperature T2 and a tank oil-temperature actually-measured value Tx after the ignition switch is turned off.

Generally, the parameters related to the torque correction control as mentioned above are temporarily stored in predetermined RAM(s), and are reset (cleared) when the ignition switch is turned off. Hence, if the ignition switch is turned on again in a short time after the turnoff of ignition switch, namely if a time interval between the turnoff and a restart of the engine is short; a relatively large deviation is caused between the tank oil-temperature estimate value T0 and the tank oil-temperature actually-measured value Tx. Hence, there has been a problem that an appropriate correction of the assist torque is difficult to attain. Therefore, in this embodiment, a self-maintaining function is provided which continues to calculate the tank oil-temperature estimate value T0 without shutting down the power supply of the microcomputer 62 until a predetermined time period has elapsed after the ignition switch was turned off.

The above-mentioned deviation between the tank oil-temperature estimate value T0 and the tank oil-temperature actually-measured value Tx after the turnoff of ignition switch will now be explained in a concrete form. As shown in FIG. 10, a temperature variation of the tank oil-temperature actually-measured value Tx is very slow (gradual) as compared with that of the FET temperature T2. Hence, a relatively large deviation is caused between the tank oil-temperature estimate value T0 and the tank oil-temperature actually-measured value Tx immediately after the ignition switch is turned off. Afterward, with a lapse of time, the temperature variation of the FET temperature T2 becomes slow so that the deviation between the tank oil-temperature estimate value T0 and the tank oil-temperature actually-measured value Tx is gradually reduced. Then, variation amounts of the FET temperature T2 and the tank oil-temperature actually-measured value Tx become substantially constant when and after approximately 1500 seconds have elapsed. As a result, the deviation between the tank oil-temperature estimate value T0 and the tank oil-temperature actually-measured value Tx becomes substantially constant. From such experimental results, a continuation time (duration time of active state) of the above-mentioned self-maintaining function is set at 1000 seconds in this embodiment, also in consideration of a burden on vehicle-mounted battery.

Thus, in this embodiment, the self-maintaining-function control section 93 continues to calculate the tank oil-temperature estimate value T0 without shutting off the power supply to the microcomputer 62 also after the ignition switch was turned off. Specifically, the self-maintaining-function control section 93 continues to calculate the tank oil-temperature estimate value T0 until the predetermined time (1000 seconds) has elapsed after the ignition switch was turned off. Accordingly, an accuracy of the tank oil-temperature estimate value T0 can be improved in the case that the ignition switch is turned on again within the predetermined time (1000 seconds).

Moreover, the continuation time of the self-maintaining function is determined based on the above-mentioned experimental results in this embodiment. Accordingly, under a predetermined high-temperature condition (of the FET temperature T2) where the FET temperature T2 relatively greatly influences the estimation of the tank oil-temperature estimate value T0, the self-maintaining function is continued to improve the estimation accuracy of the tank oil temperature T0. On the other hand, under a predetermined low-temperature condition where the FET temperature T2 is regarded as having a relatively low influence on the estimation of the tank oil-temperature estimate value T0, the self-maintaining function is deactivated so that an unnecessary power supply to the nonvolatile RAM 63 can be inhibited to reduce the load applied to the vehicle-mounted battery.

According to this embodiment, the predetermined continuation time is not limited to 1000 seconds mentioned in the above example of this embodiment. The predetermined continuation time can be freely set, for example, in dependence upon a specification of vehicle-mounted object. As understood from the experimental results, the estimation of the tank oil temperature T0 is more influenced as the FET temperature T2 is higher. Hence, the predetermined continuation time may be varied according to the FET temperature T2 instead of being set at the fixed value mentioned above. For example, the predetermined continuation time may be set at a longer value as the FET temperature T2 is higher.

Next, concrete control contents of the self-maintaining-function control section 93 will now be explained referring to FIG. 11.

FIG. 11 is a flowchart showing a control flow in the self-maintaining-function control section 93.

In the self-maintaining-function control section 93, at first, it is judged whether or not the ignition switch 74 is in OFF state at step S301. If the ignition switch 74 is not in OFF state, this control flow is ended. If the ignition switch 74 is in OFF state, the program proceeds to step S302 in order to perform a judgment on after-mentioned predetermined requirements.

At step S302, it is judged whether or not all of the following three requirements (criteria) are satisfied. As first one of the three requirements, it is judged whether or not the first fail safe control which is caused by the detection of the failure detection signal θx of steering angle sensor 73 or the failure detection signal T1x of thermistor 65 is inactive (in non-execution). As second one of the three requirements, it is judged whether or not a value obtained by subtracting the tank oil-temperature estimate value T0 from the thermistor-temperature signal T1 exceeds a prescribed value (which is set at 18° C. corresponding to the above-mentioned steady-state deviation in this embodiment). As third one of the three requirements, it is judged whether or not an after-mentioned self-maintaining timer variable is smaller than 1000 seconds.

If at least one of the three requirements is not satisfied, the self-maintaining function is not executed so that this control flow is ended. On the other hand, if all of the three requirements are satisfied (i.e., respective judgment results of the three requirements are all “YES”), the program proceeds to step S303. At step S303, the self-maintaining timer variable which is memorized in the nonvolatile RAM 63 is incremented (increased), and the self-maintaining function is executed. Then, the program proceeds to step S304.

At step S304, it is judged whether or not the ignition switch 74 has been turned on, i.e., whether or not the engine has been restarted. If the ignition switch 74 has not been turned on yet; this control flow is ended, and the calculation of the tank oil-temperature estimate value T0 is ongoingly continued. On the other hand, if the ignition switch 74 has been turned on, the program proceeds to step S305 since the self-maintaining function does not need to be executed any more. At step S305, the self-maintaining timer variable of the nonvolatile RAM 63 is cleared (reset). Then, the program proceeds to step S306.

At step S306, it is judged whether or not the first fail safe control is in execution. If the first fail safe control is in execution, this control flow is ended since the above-mentioned correction of assist torque is not carried out. On the other hand, if the first fail safe control is not in execution, the program proceeds to step S307. At step S307, all variables related to the torque correction control are initialized, and this control flow is ended.

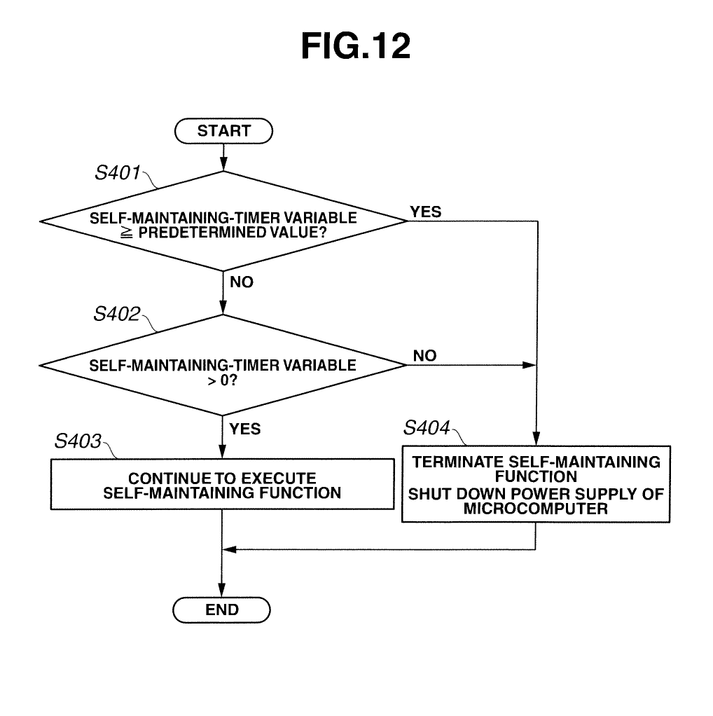

The self-maintaining function is not necessarily executed only in order to continue to calculate the tank oil-temperature estimate value T0. The self-maintaining function is executed also, for example, in a case that a predetermined data is being written in the nonvolatile RAM 63 (i.e., in a case that the ignition switch is turned off during a writing process of a predetermined data), and in a case that a heating protection program for the electric motor 50 is in execution (i.e., in a case that the ignition switch is turned off during a heating protection program for the electric motor 50). Therefore, a control flow for judging the execution of the self-maintaining function in the self-maintaining-function control section 93 will now be explained referring to FIG. 12, which works in conjunction with the control flow of FIG. 11. That is, a general control flow for judging the execution of the self-maintaining function will now be explained separately from FIG. 11.

In the self-maintaining-function control section 93, at first, it is judged whether or not the self-maintaining timer variable stored in the nonvolatile RAM 63 is larger than or equal to a predetermined value, at step S401. If the self-maintaining timer variable is larger than or equal to the predetermined value, the program proceeds to step S404. At step S404, the execution of the self-maintaining function is finished, and a signal for shutting off power supply to the microcomputer 62 is outputted to the microcomputer power-supply section 94. The predetermined value of step S401 corresponds to a continuation time of execution of the self-maintaining function, and is a reference value which can be determined according to an intended purpose of the self-maintaining function. For example, the predetermined value of step S401 is equal to 1000 (seconds) in the case of above-mentioned calculation of the tank oil-temperature estimate value T0.

On the other hand, if the self-maintaining timer variable is smaller than the predetermined value at step S401, the program proceeds to step S402. At step S402, it is judged whether or not the self-maintaining timer variable is larger than 0, i.e., whether or not the ignition switch has been turned on again. If the ignition switch has not yet been turned on, namely if the self-maintaining timer variable is larger than 0; the program proceeds to step S403. At step S403, the execution of the self-maintaining function is continued, and this control flow is ended. If the ignition switch has been already turned on, namely if the self-maintaining timer variable is not larger than 0; the program proceeds to step S404 since the self-maintaining function does not need to be executed any more. At step S404, the execution of the self-maintaining function is terminated, and a command signal for shutting off the power of the microcomputer 62 is outputted to the microcomputer power-supply section 94. Then, this control flow is ended.

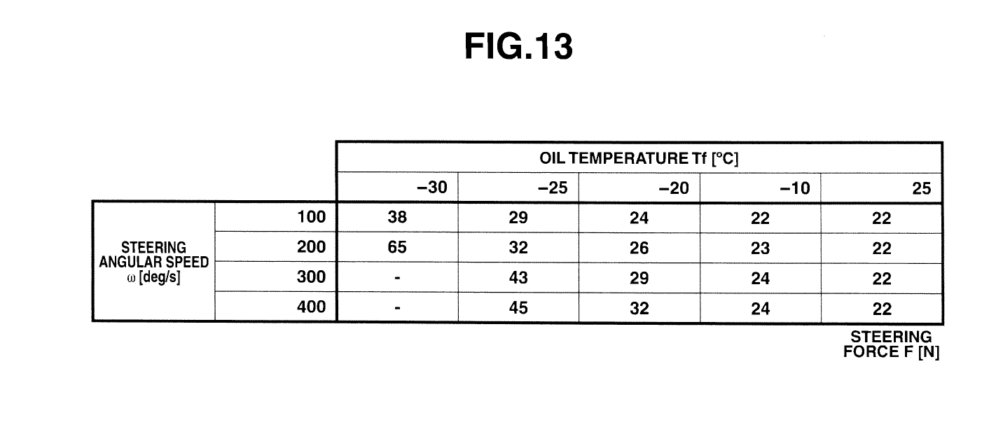

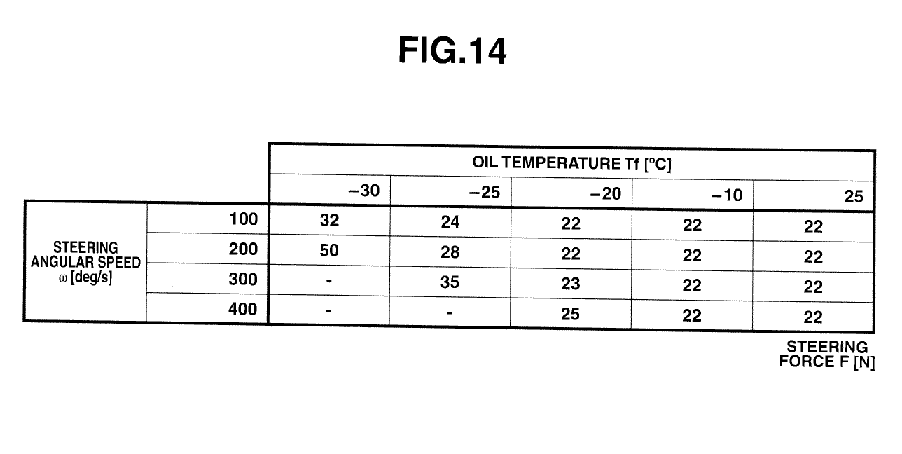

Advantageous effects of torque correction control in the above-explained power steering apparatus according to the present invention will now be explained in detail, referring to FIGS. 13 and 14.

FIG. 13 is a view showing steering forces F based on the steering angular speed ω and the oil temperature Tf in a power steering apparatus of comparative earlier technique. FIG. 14 is a view showing steering forces F based on the steering angular speed ω and the oil temperature Tf in the power steering apparatus according to the embodiment of the present invention. Both of FIGS. 13 and 14 show the respective steering forces F indicated when the steering wheel is manipulated under a stopped state of vehicle (i.e., by a stationary steering).

As recognized from a comparison between FIGS. 13 and 14, a difference of the steering force F between the power steering apparatus of comparative technique and the power steering apparatus according to the embodiment of the present invention does not exist when the oil temperature Tf is equal to 25° C. which is an ordinary (room) temperature. However, when the oil temperature Tf is lower than or equal to 10° C., the steering force F in the power steering apparatus according to the embodiment of the present invention is lower than the steering force F in the power steering apparatus of comparative technique over a substantially entire range of the steering angular speed ω. As is clear from such a result, the power steering apparatus according to the embodiment of the present invention can reduce a pressure loss in the respective pipe passages L1 and L2 and the like which becomes prominent due to an increased viscosity caused by a lowering of the oil temperature Tf, as compared with the power steering apparatus of comparative earlier technique.

Moreover, as recognized from the comparison between FIGS. 13 and 14; the difference of the steering force F between the power steering apparatus of comparative technique and the power steering apparatus according to the embodiment of the present invention is greater as the oil temperature Tf becomes lower, and the this difference is greater as the steering angular speed ωbecomes higher. As understood from such a result, the torque correction control of the power steering apparatus according to the embodiment of the present invention produces a more advantageous effect as the oil temperature Tf correlated with the viscosity of working oil becomes lower and as the steering angular speed ωcorrelated with the flow speed of working oil becomes higher.

In other words, as recognized from the result of FIG. 13 (comparative technique), the steering force F becomes greater as the oil temperature Tf becomes lower and also as the flow speed becomes higher. That is, the pressure loss is increased more as the oil temperature Tf becomes lower and also as the flow speed becomes higher. However, in order to offset (cancel) such a pressure loss, the power steering apparatus according to the embodiment of the present invention is configured to increase the correction control current Ic (correction torque CTr) more as the flow speed (steering angular speed ω) becomes higher and as the oil temperature Tf becomes lower. Accordingly, the above-mentioned pressure loss can be effectively reduced.

Thus, in the power steering apparatus according to the embodiment of the present invention, the assist current Io to be supplied to the electric motor 50 is corrected to be increased based on the flow speed of working oil (steering angular speed ω) and the oil temperature Tf which influences a steering responsivity. Therefore, a steering responsivity at the time of low temperature is improved, i.e., can be brought close to a steering responsivity at the time of ordinary temperature.

The torque correction control according to the embodiment of the present invention is constructed to lighten or reduce the steering force F (steering load) which is easily regarded as the steering responsivity by the driver. Therefore, an effective improvement of the steering responsivity can be ensured.

In the power steering apparatus according to the embodiment of the present invention, the pump 30, the reservoir tank 40, the electric motor 50 and the ECU 60 are arranged integrally. Specifically, the reservoir tank 40 covers a portion (the axially another end side) of the pump 30, and the EUC 60 is provided in contact with the pump 30. Accordingly, the difference between the working-oil temperature inside the pump 30 and the working-oil temperature inside the reservoir tank 40 which are able to greatly affect the steering responsivity is made to be small. Therefore, the above-mentioned correction of steering assist torque can be performed more properly.

Moreover, because of the integral arrangement of the pump 30, the reservoir tank 40, the electric motor 50 and the ECU 60, the difference between the working-oil temperature inside the reservoir tank 40 and the ambient temperature of the ECU 60 is made to be small. Therefore, the estimation accuracy of the tank oil temperature Tf can be improved when estimating the tank oil temperature Tf by using the ambient temperature of the ECU 60.

At this time, the thermistor 65 mounted on the circuit board 61 of the ECU 60 is used as a temperature sensor for the correction. Accordingly, a mountability of the temperature sensor (thermistor 65) is favorable, and the temperature sensor can be easily connected electrically with the circuit board 61. Therefore, the simplification of the apparatus and the reduction in manufacturing cost can be achieved.

The present invention is not limited to the structures of the above embodiments. For example, the respective structures of the pump 30 and the electric motor 50 which are mounted in the power steering apparatus can be freely changed according to a specification of vehicle and the like to which the power steering apparatus is applied.

Moreover, in the above embodiment, from a view point of reducing the manufacturing cost of the apparatus, the working-oil temperature inside the reservoir tank 40 is estimated from the heating temperature T1 of the thermistor 65 provided in the ECU 60. However, the present invention is not limited to this. According to the present invention, a temperature sensor may be provided in the reservoir tank 40 so that the tank oil temperature Tf can be directly sensed by this temperature sensor. In this case, the working-oil temperature inside the reservoir tank 40 can be accurately grasped, and therefore, a correction accuracy of the steering assist torque can be improved.

Moreover, in the above embodiment; the flow speed of working oil is not directly sensed. Instead, from a viewpoint that the flow speed of working oil is reflected indirectly by the steering angular speed ω correlated with the flow speed of working oil, the assist torque is corrected on the basis of this steering angular speed ω. However, the present invention is not limited to this. According to the present invention, an actual flow speed of working oil may be estimated from the steering angular speed ω, and the steering assist torque may be corrected based on this estimated flow speed.

Moreover, according to the present invention, the actual flow speed of working oil may be directly sensed by using any sensor capable of sensing a flow speed of liquid. In this case, the steering assist torque can be corrected based on this directly-sensed flow speed.

Moreover, in the above embodiment, the steering-angular-speed calculating section 110 calculates the steering angular speed ω from the steering angle signal θ sensed by the steering angle sensor 73. However, according to the present invention, the steering angular speed ω can be calculated from a moving speed (stroke speed) of the rack shaft 14 by providing a speed sensor for sensing the moving speed of the rack shaft 14. Alternatively, the steering angular speed ω can be calculated or estimated from a moved amount (stroke amount) of the rack shaft 14 by providing a stroke sensor for sensing the moved amount of the rack shaft 14.

In such a case, the flow speed of working oil may be estimated based on the moving speed of the rack shaft 14, although the flow speed of working oil is estimated based on the steering angular speed ω in the above embodiment. That is, the flow speed of working oil may be estimated based on a working-fluid amount moved between the both pressure chambers P1 and P2 which is obtained by multiplying the cross-sectional area of the piston 22 by the moving speed of the rack shaft 14. Thereby, the steering assist torque may be corrected based on this estimated flow speed. Also in this case, since the moving speed of rack shaft 14 can be easily detected, the simplification of the apparatus and the reduction of manufacturing cost are achieved as compared with the case that the flow speed of working oil itself is directly sensed.

Some technical structures obtainable from the above embodiments according to the present invention will now be listed with their advantageous effects.

[a] A power steering apparatus comprising: a power cylinder (20 in the case of above embodiment) formed with a pair of first and second pressure chambers (P1, P2) separated from each other inside the power cylinder (20), wherein the power cylinder (20) is configured to assist a steering force of a steering mechanism (13, 14) by means of a pressure difference between the pair of first and second pressure chambers (P1, P2), the steering mechanism (13, 14) being linked with a road wheel of vehicle; a bidirectional pump (30) including a pair of first and second discharge ports (42a, 42b) connected to the pair of first and second pressure chambers (P1, P2) of the power cylinder (20), wherein the bidirectional pump (30) is configured to supply working fluid selectively to the pair of first and second pressure chambers (P1, P2) by means of bidirectional rotation; a first oil passage (43a) connecting the first pressure chamber (P1) with the first discharge port (42a); a second oil passage (43b) connecting the second pressure chamber (P2) with the second discharge port (42b); a flow speed detecting section (73) configured to detect or estimate a flow speed of working fluid flowing in a hydraulic circuit constituted by the power cylinder (20), the bidirectional pump (30) and the first and second oil passages (43a, 43b); a fluid temperature detecting section (65) configured to detect or estimate a temperature of the working fluid; a torque sensor (71) configured to detect a steering torque which is applied to the steering mechanism (13, 14); an electric motor (50) configured to drive the bidirectional rotation of the bidirectional pump (30); and a motor control circuit (4) configured to control the electric motor (50). This motor control circuit (4) includes a base-current command value calculating circuit (83) configured to calculate a current command value (Ib) for controlling the electric motor (50) on the basis of the steering torque; a corrected-current command-value calculating circuit (85, 86) configured to calculate a corrected-current command value (Io) which is a corrected value of the current command value (Ib) calculated by the base-current command value calculating circuit (83), wherein the corrected-current command-value calculating circuit (85, 86) is configured to calculate the corrected-current command value (Io) to cause the corrected-current command value (Io) to become larger from the current command value (Ib) as the flow speed is higher and as the working-fluid temperature is lower; and a motor drive circuit (100, 101) configured to drive the electric motor (50) on the basis of the corrected-current command value (Io).

Accordingly, as an advantageous effect, for example, the variation of steering assist force based on the pressure loss which is caused in the pipe passages or the like due to the viscosity variation of working fluid can be sufficiently suppressed.

The power steering apparatus as described in the above item [a], wherein the corrected-current command-value calculating circuit (85, 86) is configured to calculate the corrected-current command value (Io) to cause a first rate (Δ1) to be smaller than a second rate (Δ2), wherein the first rate (Δ1) is defined by an increased amount of a correction amount for the current command value (Ib) relative to an increased amount of the flow speed in a region higher than or equal to a predetermined value of the flow speed under a constant condition of the fluid temperature, wherein the second rate (Δ2) is defined by an increased amount of the correction amount relative to the increased amount of the flow speed in a region lower than the predetermined value of the flow speed under the constant condition of the fluid temperature.

According to this structure, since the boundary characteristic between working fluid and inner wall surfaces of the pump and the pipe passages is varied according to the flow speed of working fluid, the increased amount of the correction amount for the current command value is set according to this change of boundary characteristic. Therefore, an occurrence of strangeness feeling of steering (for example, excessive light steering) can be suppressed.

[c] The power steering apparatus as described in the above item [b], wherein the corrected-current command-value calculating circuit (85, 86) is configured to calculate the corrected-current command value (Io) to reduce a rate of the first rate (Δ1) relative to the second rate (Δ2) as the fluid temperature becomes lower.

According to this structure, since the boundary characteristic between working oil and the inner wall surfaces of the pump and the pipe passages which is varied nonlinearly according to the flow speed of working fluid as mentioned above is varied also according to the working-fluid temperature, the increased amount of the correction amount for the current command value is set according to this change of boundary characteristic, i.e., according to the working-fluid temperature. Therefore, the strangeness feeling of steering (for example, excessive light steering) can be suppressed.

[d] The power steering apparatus as described in the above item [a], wherein the corrected-current command value (Io) is a sum of the current command value (Ib) calculated by the base-current command value calculating circuit (83) and a correction value calculated based on the flow speed and the fluid temperature.

According to this structure, the current command value (Ib) itself which is calculated by the base-current command value calculating circuit (83) is not changed (i.e., is used as a baseline value), there is no risk that a characteristic of steering assist torque relative to the steering torque of driver is greatly varied. As a result, a strangeness feeling of steering such as the excessively light-steering feeling can be suppressed.

[e] The power steering apparatus as described in the above item [d], wherein the corrected-current command-value calculating circuit (85, 86) is configured to calculate the corrected-current command value (Io) to prevent the correction value from exceeding a predetermined upper limit value (CTrx).

According to this structure, even if the correction value is calculated as an excessively large value due to an output failure of a sensor which is used for calculating the correction value, the calculated correction value is readjusted not to exceed its permissible upper limit and then is used for calculating the corrected-current command value. Therefore, the strangeness feeling of steering such as the excessively light-steering feeling can be suppressed.

[f] The power steering apparatus as described in the above item [e], wherein the power steering apparatus further comprises a vehicle-speed receiving section configured to receive a vehicle speed information (V) from a vehicle-speed sensor (72) mounted in the vehicle, wherein the corrected-current command-value calculating circuit (85, 86) is configured to calculate the corrected-current command value (Io) to set the predetermined upper limit value (CTrx) at a smaller value as the vehicle speed becomes higher.

That is, as the vehicle speed is higher; a magnitude of necessary steering assist torque becomes smaller, and the strangeness feeling of steering due to excessively large steering assist torque becomes greater. Hence, the upper limit value is set according to the vehicle speed. Therefore, the steering assist torque can be inhibited from being set excessively high at the time of high vehicle speed, while a steering load at the time of low vehicle speed can be reduced.

[g] The power steering apparatus as described in the above item [a], wherein the flow speed is calculated based on an actual number of revolutions per unit time of the bidirectional pump (30).

That is, the discharge rate (flow rate) of pump can be obtained by multiplying the number of revolutions per unit time of the pump by an intrinsic discharge amount (discharge amount per one rotation) of the pump. Since this intrinsic discharge amount is a fixed value, the flow speed of working fluid can be obtained by sensing the actual number of revolutions per unit time of the pump. In this case, the actual rotational speed of the pump can be sensed easily. Therefore, the simplification of the apparatus and the reduction of manufacturing cost can be attained as compared with the case that the flow speed of working fluid is directly detected.

[h] The power steering apparatus as described in the above item [a], wherein the power steering apparatus further comprises a speed sensor for sensing a moving speed of a piston (22) of the power cylinder (20), wherein the flow speed is calculated based on the moving speed of the piston (22).

That is, the discharge rate (flow rate) of pump is obtained by multiplying a pressure-receiving area of the piston by a movement distance per unit time of the piston. Since the pressure-receiving area of the piston is a fixed value, the flow speed of working fluid can be obtained by sensing a moving speed of the piston which is equal to the movement distance per unit time of the piston. In this case, the moving speed of the piston can be easily sensed. Therefore, the simplification of the apparatus and the cost reduction can be attained as compared with the case that the flow speed itself is directly sensed.

[i] A power steering apparatus comprising: a power cylinder (20) formed with a pair of first and second pressure chambers (P1, P2) separated from each other inside the power cylinder (20), wherein the power cylinder (20) is configured to assist a steering force of a steering mechanism (13, 14) by means of a pressure difference between the pair of first and second pressure chambers (P1, P2), the steering mechanism (13, 14) being linked with a road wheel of vehicle; a bidirectional pump (30) including a pair of first and second discharge ports (42a, 42b) connected to the pair of first and second pressure chambers (P1, P2) of the power cylinder (20), wherein the bidirectional pump (30) is configured to supply working fluid selectively to the pair of first and second pressure chambers (P1, P2) by means of bidirectional rotation; a first oil passage (43a) connecting the first pressure chamber (P1) with the first discharge port (42a); a second oil passage (43b) connecting the second pressure chamber (P2) with the second discharge port (42b); a reservoir tank (40) retaining working fluid to adjust an amount of working fluid flowing in a hydraulic circuit constituted by the power cylinder (20), the bidirectional pump (30) and the first and second oil passages (43a, 43b); a flow speed detecting section (73) configured to detect or estimate a flow speed of working fluid flowing in the hydraulic circuit; a torque sensor (71) configured to detect a steering torque which is applied to the steering mechanism (13, 14); a motor drive device (MC) including an electric motor (50) and a motor control circuit (4), wherein the electric motor (50) is provided to the bidirectional pump (30) and configured to drive the bidirectional rotation of the bidirectional pump (30), wherein the motor control circuit (4) is configured to control the electric motor (50); a control circuit housing (51) receiving the motor control circuit (4); and a temperature sensor (65) provided in the reservoir tank (40) or the control circuit housing (51) and configured to sense a working-fluid temperature or an ambient temperature inside the control circuit housing (51) which serves as a correction-purpose temperature. The motor control circuit (4) includes a base-current command value calculating circuit (83) configured to calculate a current command value (Ib) for controlling the electric motor (50) on the basis of the steering torque; a corrected-current command-value calculating circuit (85, 86) configured to calculate a corrected-current command value (Io) which is a corrected value of the current command value (Ib) calculated by the base-current command value calculating circuit (83), wherein the corrected-current command-value calculating circuit (85, 86) is configured to calculate the corrected-current command value (Io) to cause the corrected-current command value (Io) to become larger from the current command value (Ib) as a steering angular speed (w) is higher and as the correction-purpose temperature is lower; and a motor drive circuit (100, 101) configured to drive the electric motor (50) on the basis of the corrected-current command value (Io).

As an advantageous effect, for example, the variation of steering assist force based on the pressure loss which is caused in the pipe passages or the like due to the viscosity variation of working fluid can be sufficiently suppressed as mentioned above.

[j] The power steering apparatus as described in the above item [i], wherein the motor control circuit (4) includes a circuit board (61) on which a microcomputer (62) and an electric circuit are mounted for controlling the electric motor (50), wherein the temperature sensor (65) is mounted on the circuit board (61) and configured to sense the ambient temperature inside the control circuit housing (51).

According to this structure, since the temperature sensor (65) is mounted on the circuit board 61 for controlling the motor, a mountability of the temperature sensor is improved while a connectivity between the temperature sensor and the other electronic circuits is also improved. At this time, the temperature sensor does not directly sense the fluid temperature. However, since the circuit board 61 is located near the reservoir tank, the estimation accuracy of fluid temperature is enhanced by sensing the ambient temperature inside the control circuit housing by the temperature sensor.

[k] The power steering apparatus as described in the above item [j], wherein the motor drive circuit (100, 101) includes a FET (64), wherein the corrected-current command-value calculating circuit (85, 86) is configured to calculate the corrected-current command value (Io) on the basis of an information obtained by subtracting a heating temperature (heating quantity) caused by an energization of the FET (64) from the correction-purpose temperature sensed by the temperature sensor (65).

That is, in the case that the FET(s) functioning as a heating source is provided inside the control circuit housing, the ambient temperature sensed by the temperature sensor includes a heating quantity of the FET. However, the working fluid inside the reservoir tank is little influenced by the heating of the FET. Therefore, by subtracting the heating temperature (heating quantity) of the FET from the temperature (heating quantity) sensed by the temperature sensor, a higher estimation accuracy of fluid temperature can be achieved.

[l] The power steering apparatus as described in the above item [k], wherein the power steering apparatus further comprises a nonvolatile memory (63) configured to store the information of the heating temperature of the FET (64) until a predetermined time length has elapsed after a power circuit of the vehicle was shut down, wherein the corrected-current command-value calculating circuit (85, 86) is configured to calculate the corrected-current command value (Io) on the basis of the information of the heating temperature of the FET (64) stored by the nonvolatile memory (63) when the power circuit of the vehicle is energized before the predetermined time length has elapsed.

That is, in a case that the information of the heating temperature of the FET is not kept after the power circuit of vehicle was shut down, an appropriate temperature estimation taking the heating temperature of the FET into consideration cannot be performed when the power circuit of vehicle is restarted before the heating temperature of the FET has been lowered. Contrarily, according to the above structure, the appropriate temperature estimation can be performed even if the power circuit of vehicle is restarted before the heating temperature of the FET has been lowered. Therefore, the accuracy of temperature estimation can be improved.

[m] The power steering apparatus as described in the above item [l], wherein the nonvolatile memory (63) is configured to store the information of the heating temperature of the FET (64) during an energization of the nonvolatile memory (63) and configured to delete the information of the heating temperature of the FET (64) when the energization of the nonvolatile memory (63) is shut down, wherein a time length of the energization of the nonvolatile memory (63) after the power circuit of the vehicle was shut down which corresponds to the predetermined time length is set at a longer value as the heating temperature of the FET (64) is higher.

That is, as the heating temperature by the FET is higher, this heating temperature influences the ambient temperature for a longer time. According to the above structure, the time length for which the nonvolatile memory keeps the temperature information of the FET is set in dependence upon the heating temperature of the FET. Therefore, unnecessary energization to the nonvolatile memory can be suppressed while improving the accuracy of temperature estimation.

[n] The power steering apparatus as described in the above item [j], wherein the corrected-current command-value calculating circuit (85, 86) is configured to calculate the corrected-current command value (Io) on the basis of an information obtained by subtracting a heating temperature of the microcomputer (62) of the motor control circuit (4) from the correction-purpose temperature sensed by the temperature sensor (65).

That is, since the microcomputer functioning as a heating source is provided inside the control circuit housing, the ambient temperature sensed by the temperature sensor includes a heating quantity of the microcomputer. However, the working fluid inside the reservoir tank is little influenced by the heating of the microcomputer. Therefore, by subtracting the heating temperature (heating quantity) of the microcomputer from the temperature sensed by the temperature sensor, a higher estimation accuracy of fluid temperature can be achieved.

[o] The power steering apparatus as described in the above item [j], wherein if an information of the correction-purpose temperature derived from the temperature sensor (65) is abnormal, the corrected-current command-value calculating circuit (85, 86) is configured to calculate the corrected-current command value (Io) on the basis of a predetermined backup temperature value which is a fixed value, by setting the correction-purpose temperature to the predetermined backup temperature value.

That is, if the steering assist force is produced by using the abnormal information under the state where the information of the correction-purpose temperature sensed by the temperature sensor is abnormal, there is a risk that the steering feeling is worsened as compared with a non-corrected state. According to the above structure, in the case that the information of the correction-purpose temperature sensed by the temperature sensor is not normal, the predetermined backup temperature value is used which has been determined as the correction-purpose temperature by experiments and the like. Therefore, the worsening of the steering feeling can be inhibited.

[p] The power steering apparatus as described in the above item [i], wherein the temperature sensor (65) is mounted in the reservoir tank (40) and is configured to sense a temperature of working fluid retained inside the reservoir tank (40).

According to this structure, the temperature sensor directly senses the temperature of working fluid. Therefore, a further accurate information of fluid temperature can be obtained resulting in the achievement of more appropriate correction.

[q] The power steering apparatus as described in the above item [p], wherein at least a part of the bidirectional pump (30) is soaked in the working fluid retained inside the reservoir tank (40).

According to this structure, since the bidirectional pump is surrounded by working fluid retained in the reservoir tank, the difference between the temperature of working fluid inside the tank and the temperature of working fluid inside the pump which greatly influences the steering responsivity can be reduced. Therefore, a more appropriate correction for the current command value can be attained.

[r] A power steering apparatus comprising: a power cylinder (20) formed with a pair of first and second pressure chambers (P1, P2) separated from each other inside the power cylinder (20), wherein the power cylinder (20) is configured to assist a steering force of a steering mechanism (13, 14) by means of a pressure difference between the pair of first and second pressure chambers (P1, P2), the steering mechanism (13, 14) being linked with a road wheel of vehicle; a bidirectional pump (30) including a pair of first and second discharge ports (42a, 42b) connected to the pair of first and second pressure chambers (P1, P2) of the power cylinder (20), wherein the bidirectional pump (30) is configured to supply working fluid selectively to the pair of first and second pressure chambers (P1, P2) by means of bidirectional rotation; a first oil passage (43a) connecting the first pressure chamber (P1) with the first discharge port (42a); a second oil passage (43b) connecting the second pressure chamber (P2) with the second discharge port (42b); a steering speed detecting section configured to detect or estimate a steering speed of a steering wheel linked with the steering mechanism (13, 14); a fluid temperature detecting section (65) configured to detect or estimate a temperature of working fluid; a torque sensor (71) configured to detect a steering torque which is applied to the steering mechanism (13, 14); an electric motor (50) configured to drive the bidirectional rotation of the bidirectional pump (30); and a motor control circuit (4) configured to control the electric motor (50). The motor control circuit (4) includes a base-current command value calculating circuit (83) configured to calculate a current command value (Ib) for controlling the electric motor (50) on the basis of the steering torque; a corrected-current command-value calculating circuit (85, 86) configured to calculate a corrected-current command value (Io) which is a corrected value of the current command value (Ib) calculated by the base-current command value calculating circuit (83), wherein the corrected-current command-value calculating circuit (85, 86) is configured to calculate the corrected-current command value (Io) to cause the corrected-current command value (Io) to become larger from the current command value (Ib) as the steering speed is higher and as the working-fluid temperature is lower; and a motor drive circuit (100, 101) configured to drive the electric motor (50) on the basis of the corrected-current command value (Io).

As an advantageous effect, for example, the variation of steering assist force based on the pressure loss which is caused in the pipe passages or the like due to the viscosity variation of working fluid can be sufficiently suppressed as mentioned above.

[s] The power steering apparatus as described in the above item [r], wherein the corrected-current command-value calculating circuit (85, 86) includes a filter circuit (111, 113) configured to extract a frequency component of electric signal which is lower than a predetermined frequency, wherein the corrected-current command-value calculating circuit (85, 86) is configured to calculate the corrected-current command value (Io) on the basis of an output signal obtained through the filter circuit (111, 113) from the steering speed detecting section.

That is, the information of steering speed has an information unrelated to the steering intention of driver and/or an information of abrupt change such as an abrupt turning (abrupt steering operation) by the driver. If the corrected-current command value is varied strictly also for such unintentional change and the abrupt change, there is a risk that the steering feeling is worsened. Hence, according to the above structure, the steering-speed signal is passed through the predetermined filter circuit. Therefore, the abrupt change of the corrected-current command value is suppressed resulting in the improvement of steering feeling.

[t] The power steering apparatus as described in the above item [r], wherein the motor drive circuit (100, 101) is configured to drive the electric motor (50) by setting the current command value (Ib) calculated by the base-current command value calculating circuit (83) as the corrected-current command value (Io), if the corrected-current command-value calculating circuit (85, 86) determines that an information of the steering speed derived from the steering speed detecting section is abnormal.

That is, if the steering assist force is produced by using the abnormal information under the state where the steering-speed information inputted from the steering speed detecting section is not normal (failed), there is a risk that the steering feeling is worsened as compared with a non-corrected state. According to the above structure, in the case that the information of the steering-speed information inputted from the steering speed detecting section is not normal, the correction for the current command value is stopped. Therefore, the worsening of the steering feeling can be suppressed.

This application is based on prior Japanese Patent Application No. 2010-108917 filed on May 11, 2010. The entire contents of this Japanese Patent Application are hereby incorporated by reference.

Although the invention has been described above with reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A power steering apparatus comprising:
a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle;
a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation;
a first oil passage connecting the first pressure chamber with the first discharge port;
a second oil passage connecting the second pressure chamber with the second discharge port;
a flow speed detecting section configured to detect or estimate a flow speed of working fluid flowing in a hydraulic circuit constituted by the power cylinder, the bidirectional pump and the first and second oil passages;
a fluid temperature detecting section configured to detect or estimate a temperature of the working fluid;
a torque sensor configured to detect a steering torque which is applied to the steering mechanism;
an electric motor configured to drive the bidirectional rotation of the bidirectional pump; and
a motor control circuit configured to control the electric motor, the motor control circuit including
a base-current command value calculating circuit configured to calculate a current command value for controlling the electric motor on the basis of the steering torque,
a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as the flow speed is higher and as the working-fluid temperature is lower, and
a motor drive circuit configured to drive the electric motor on the basis of the corrected-current command value.

2. The power steering apparatus as claimed in claim 1,
wherein the corrected-current command-value calculating circuit is configured to calculate the corrected-current command value to cause a first rate to be smaller than a second rate,
wherein the first rate is defined by an increased amount of a correction amount for the current command value relative to an increased amount of the flow speed in a region higher than or equal to a predetermined value of the flow speed under a constant condition of the fluid temperature,
wherein the second rate is defined by an increased amount of the correction amount relative to the increased amount of the flow speed in a region lower than the predetermined value of the flow speed under the constant condition of the fluid temperature.

3. The power steering apparatus as claimed in claim 2,
wherein the corrected-current command-value calculating circuit is configured to calculate the corrected-current command value to reduce a rate of the first rate relative to the second rate as the fluid temperature becomes lower.

4. The power steering apparatus as claimed in claim 1,
wherein the corrected-current command value is a sum of the current command value calculated by the base-current command value calculating circuit and a correction value calculated based on the flow speed and the fluid temperature.

5. The power steering apparatus as claimed in claim 4,
wherein the corrected-current command-value calculating circuit is configured to calculate the corrected-current command value to prevent the correction value from exceeding a predetermined upper limit value.

6. The power steering apparatus as claimed in claim 5,
wherein the power steering apparatus further comprises a vehicle-speed receiving section configured to receive a vehicle speed information from a vehicle-speed sensor mounted in the vehicle,
wherein the corrected-current command-value calculating circuit is configured to calculate the corrected-current command value to set the predetermined upper limit value at a smaller value as the vehicle speed becomes higher.

7. The power steering apparatus as claimed in claim 1,
wherein the flow speed is calculated based on an actual number of revolutions per unit time of the bidirectional pump.

8. The power steering apparatus as claimed in claim 1,
wherein the power steering apparatus further comprises a speed sensor for sensing a moving speed of a piston of the power cylinder,
wherein the flow speed is calculated based on the moving speed of the piston.

9. A power steering apparatus comprising:
a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle;
a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation;
a first oil passage connecting the first pressure chamber with the first discharge port;
a second oil passage connecting the second pressure chamber with the second discharge port;
a reservoir tank retaining working fluid to adjust an amount of working fluid flowing in a hydraulic circuit constituted by the power cylinder, the bidirectional pump and the first and second oil passages;
a flow speed detecting section configured to detect or estimate a flow speed of working fluid flowing in the hydraulic circuit;
a torque sensor configured to detect a steering torque which is applied to the steering mechanism;
a motor drive device including an electric motor and a motor control circuit, wherein the electric motor is provided to the bidirectional pump and configured to drive the bidirectional rotation of the bidirectional pump, wherein the motor control circuit is configured to control the electric motor;
a control circuit housing receiving the motor control circuit; and
a temperature sensor provided in the reservoir tank or the control circuit housing and configured to sense a working-fluid temperature or an ambient temperature inside the control circuit housing which serves as a correction-purpose temperature,
wherein the motor control circuit includes
a base-current command value calculating circuit configured to calculate a current command value for controlling the electric motor on the basis of the steering torque,
a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as a steering angular speed is higher and as the correction-purpose temperature is lower, and
a motor drive circuit configured to drive the electric motor on the basis of the corrected-current command value.

10. The power steering apparatus as claimed in claim 9,
wherein the motor control circuit includes a circuit board on which a microcomputer and an electric circuit are mounted for controlling the electric motor,
wherein the temperature sensor is mounted on the circuit board and configured to sense the ambient temperature inside the control circuit housing.

11. The power steering apparatus as claimed in claim 10,
wherein the motor drive circuit includes a FET,
wherein the corrected-current command-value calculating circuit is configured to calculate the corrected-current command value on the basis of an information obtained by subtracting a heating temperature caused by an energization of the FET from the correction-purpose temperature sensed by the temperature sensor.

12. The power steering apparatus as claimed in claim 11,
wherein the power steering apparatus further comprises a nonvolatile memory configured to store the information of the heating temperature of the FET until a predetermined time length has elapsed after a power circuit of the vehicle was shut down,
wherein the corrected-current command-value calculating circuit is configured to calculate the corrected-current command value on the basis of the information of the heating temperature of the FET stored by the nonvolatile memory when the power circuit of the vehicle is energized before the predetermined time length has elapsed.

13. The power steering apparatus as claimed in claim 12,
wherein the nonvolatile memory is configured to store the information of the heating temperature of the FET during an energization of the nonvolatile memory and configured to delete the information of the heating temperature of the FET when the energization of the nonvolatile memory is shut down,
wherein a time length of the energization of the nonvolatile memory after the power circuit of the vehicle was shut down which corresponds to the predetermined time length is set at a longer value as the heating temperature of the FET is higher.

14. The power steering apparatus as claimed in claim 10,
wherein the corrected-current command-value calculating circuit is configured to calculate the corrected-current command value on the basis of an information obtained by subtracting a heating temperature of the microcomputer of the motor control circuit from the correction-purpose temperature sensed by the temperature sensor.

15. The power steering apparatus as claimed in claim 10, wherein
if an information of the correction-purpose temperature derived from the temperature sensor is abnormal, the corrected-current command-value calculating circuit is configured to calculate the corrected-current command value on the basis of a predetermined backup temperature value which is a fixed value, by setting the correction-purpose temperature to the predetermined backup temperature value.

16. The power steering apparatus as claimed in claim 9,
wherein the temperature sensor is mounted in the reservoir tank and is configured to sense a temperature of working fluid retained inside the reservoir tank.

17. The power steering apparatus as claimed in claim 16,
wherein at least a part of the bidirectional pump is soaked in the working fluid retained inside the reservoir tank.

18. A power steering apparatus comprising:
a power cylinder formed with a pair of first and second pressure chambers separated from each other inside the power cylinder, wherein the power cylinder is configured to assist a steering force of a steering mechanism by means of a pressure difference between the pair of first and second pressure chambers, the steering mechanism being linked with a road wheel of vehicle;
a bidirectional pump including a pair of first and second discharge ports connected to the pair of first and second pressure chambers of the power cylinder, wherein the bidirectional pump is configured to supply working fluid selectively to the pair of first and second pressure chambers by means of bidirectional rotation;
a first oil passage connecting the first pressure chamber with the first discharge port;
a second oil passage connecting the second pressure chamber with the second discharge port;
a steering speed detecting section configured to detect or estimate a steering speed of a steering wheel linked with the steering mechanism;
a fluid temperature detecting section configured to detect or estimate a temperature of working fluid;
a torque sensor configured to detect a steering torque which is applied to the steering mechanism;
an electric motor configured to drive the bidirectional rotation of the bidirectional pump; and
a motor control circuit configured to control the electric motor, the motor control circuit including
a base-current command value calculating circuit configured to calculate a current command value for controlling the electric motor on the basis of the steering torque,
a corrected-current command-value calculating circuit configured to calculate a corrected-current command value which is a corrected value of the current command value calculated by the base-current command value calculating circuit, wherein the corrected-current command-value calculating circuit is configured to calculate the corrected-current command value from the current command value to cause the corrected-current command value to become larger as the steering speed is higher and as the working-fluid temperature is lower, and
a motor drive circuit configured to drive the electric motor on the basis of the corrected-current command value.

19. The power steering apparatus as claimed in claim 18,
wherein the corrected-current command-value calculating circuit includes a filter circuit configured to extract a frequency component of electric signal which is lower than a predetermined frequency,
wherein the corrected-current command-value calculating circuit is configured to calculate the corrected-current command value on the basis of an output signal obtained through the filter circuit from the steering speed detecting section.

20. The power steering apparatus as claimed in claim 18,
wherein the motor drive circuit is configured to drive the electric motor by setting the current command value calculated by the base-current command value calculating circuit as the corrected-current command value, if the corrected-current command-value calculating circuit determines that an information of the steering speed derived from the steering speed detecting section is abnormal.
